(19) United States
(12) Patent Application Publication
(10) Pub. No.: US 2026/0235974 A1
(43) Pub. Date: Aug. 13, 2026

(54) IMAGE FORMING APPARATUS

(71) Applicant: CANON KABUSHIKI KAISHA, Tokyo (JP)

(72) Inventors: SEIYA ISHIKAWA, Tokyo (JP); NORITOMO YAMAGUCHI, Kanagawa (JP); AKINORI MITSUMATA, Tokyo (JP)

(21) Appl. No.: 19/534,435

(22) Filed: Feb. 9, 2026

(30) Foreign Application Priority Data
Feb. 12, 2025 (JP) 2025-020948

(51) Int. Cl. G03G 15/01; G03G 21/16

(52) U.S. Cl. CPC G03G 15/0121; G03G 15/0189; G03G 21/1633; G03G 21/1647; G03G 2221/1654

(57) ABSTRACT

An image forming apparatus includes a main body, a first developing unit including a first developing container and a first developing roller, a second developing unit including a second developing container and a second developing roller, an air supplying portion, a first toner container, a second toner container, a first passage which communicates with the first toner container and the first developing container, and a second passage which communicates with the second toner container and the second developing container. The first developing unit and the second developing unit are aligned in the second direction, and the first toner container and the second toner container are aligned in the second direction, and are respectively arranged below the first developing unit and the second developing unit in the gravity direction.

### BACKGROUND

### Field of the Technology

The present disclosure relates to an image forming apparatus that forms an image on a recording material.

### Description of the Related Art

Japanese Patent Application Laid-Open No. 2011-150001 discloses an image forming apparatus including a developing portion that performs development of a latent image, a toner storage container disposed above the developing portion, and an air pump that conveys replenishment toner discharged from the toner storage container by air toward the developing portion.

### SUMMARY

The present disclosure provides a new configuration related to an arrangement of toner containers storing toner for replenishment.

An aspect of the present disclosure provides an image forming apparatus including a main body, a first developing unit including a first developing container configured to store first toner, and a first developing roller configured to bear the first toner, a second developing unit including a second developing container configured to store second toner, and a second developing roller configured to bear the second toner, an air supplying portion configured to supply air, a first toner container that is attachable to and detachable from the main body and configured to store the first toner and discharge the first toner by the air supplied from the air supplying portion, a second toner container that is attachable to and detachable from the main body and configured to store the second toner and discharge the second toner by the air supplied from the air supplying portion, a first passage which communicates with the first toner container and the first developing container and through which the first toner passes when the first toner discharged from the first toner container is conveyed to the first developing container by the air, and a second passage which communicates with the second toner container and the second developing container and through which the second toner passes when the second toner discharged from the second toner container is conveyed to the second developing container by the air, wherein in a case where a direction of a rotation axis of the first developing roller is a first direction and a direction intersecting with both a gravity direction and the first direction is a second direction, the first developing unit and the second developing unit are aligned in the second direction, and the first toner container and the second toner container are aligned in the second direction, and are respectively arranged below the first developing unit and the second developing unit in the gravity direction.

Another aspect of the present disclosure provides an image forming apparatus including a main body, a first developing unit including a first developing container configured to store first toner, and a first developing roller configured to bear the first toner, a second developing unit including a second developing container configured to store second toner, and a second developing roller configured to bear the second toner, a moving unit that the first developing unit and the second developing unit are attachable to and detachable from and that is movable between an inner position and an outer position with respect to the main body in a state in which the first developing unit and the second developing unit are attached to the moving unit, the inner position being a position where the first developing unit and the second developing unit are in the main body, the outer position being a position where the first developing unit and the second developing unit are exposed to an outside of the main body, a first toner container that is attachable to and detachable from the main body and configured to store the first toner and discharge the first toner, a second toner container that is attachable to and detachable from the main body and configured to store the second toner and discharge the second toner, a first passage which communicates with the first toner container and the first developing container and through which the first toner passes when the first toner discharged from the first toner container is conveyed toward the first developing container, and a second passage which communicates with the second toner container and the second developing container and through which the second toner passes when the second toner discharged from the second toner container is conveyed toward the second developing container, wherein in a case where a direction of a rotation axis of the first developing roller is a first direction and a direction intersecting with both a gravity direction and the first direction is a second direction, the first developing unit and the second developing unit are aligned in the second direction, the moving unit is movable in the second direction with respect to the main body, and the first toner container and the second toner container are aligned in the second direction, and are respectively arranged below the first developing unit and the second developing unit in the gravity direction.

Another aspect of the present disclosure provides an image forming apparatus including a main body, a first developing unit provided in the main body and including a first developing container configured to store first toner, and a first developing roller configured to bear the first toner, a second developing unit provided in the main body and including a second developing container configured to store second toner, and a second developing roller configured to bear the second toner, a first toner container configured to store the first toner and discharge the first toner, a second toner container configured to store the second toner and discharge the second toner, a moving unit that the first toner container and the second toner container are attachable to and detachable from and that is movable between an inner position and an outer position with respect to the main body in a state in which the first toner container and the second toner container are attached to the moving unit, the inner position being a position where the first toner container and the second toner container are in the main body, the outer position being a position where the first toner container and the second toner container are exposed to an outside of the main body, a first passage which communicates with the first toner container and the first developing container and through which the first toner passes when the first toner discharged from the first toner container is conveyed toward the first developing container, and a second passage which communicates with the second toner container and the second developing container and through which the second toner passes when the second toner discharged from the second toner container is conveyed toward the second developing container, wherein in a case where a direction of a rotation axis of the first developing roller is a first direction and a direction intersecting with both a gravity direction and the first direction is a second direction, the first developing unit and the second developing unit are aligned in the second direction, the first toner container and the second toner container are aligned in the second direction, and are respectively arranged below the first developing unit and the second developing unit in the gravity direction, and the moving unit is movable in the second direction with respect to the main body.

Features of the present disclosure will become apparent from the following description of embodiments with reference to the attached drawings. The following description of embodiments is described by way of example.

### BRIEF DESCRIPTION OF THE DRAWINGS

FIG. 1 is a section view of an image forming apparatus according to an embodiment.

FIG. 2 is a section view of a toner replenishment unit according to the embodiment.

FIG. 3 is a perspective view illustrating one state of the image forming apparatus according to the embodiment.

FIG. 4 is a perspective view illustrating another state of the image forming apparatus according to the embodiment.

FIG. 5 is a perspective view of toner replenishment units, toner passages, and image forming units according to the embodiment.

FIG. 6 is a diagram illustrating connecting portions between toner containers and the toner passages according to the embodiment.

FIGS. 7A and 7B are each a section view illustrating attachment and detachment between the toner container and the toner passage according to the embodiment.

FIGS. 8A and 8B are each an explanatory diagram of a front door interlocking mechanism according to the embodiment.

FIGS. 9A and 9B are each a perspective view of a holding mechanism of pump units and the toner passages according to the embodiment.

FIGS. 10A to 10C are each a top view illustrating the operation of the holding mechanism in the case of drawing out a toner cartridge tray according to the embodiment.

### DESCRIPTION OF THE EMBODIMENTS

Embodiments according to the present disclosure will be described with reference to drawings. Each of the embodiments of the present disclosure described below can be implemented solely or as a combination of a plurality of the embodiments or features thereof where necessary or where the combination of elements or features from individual embodiments in a single embodiment is beneficial.

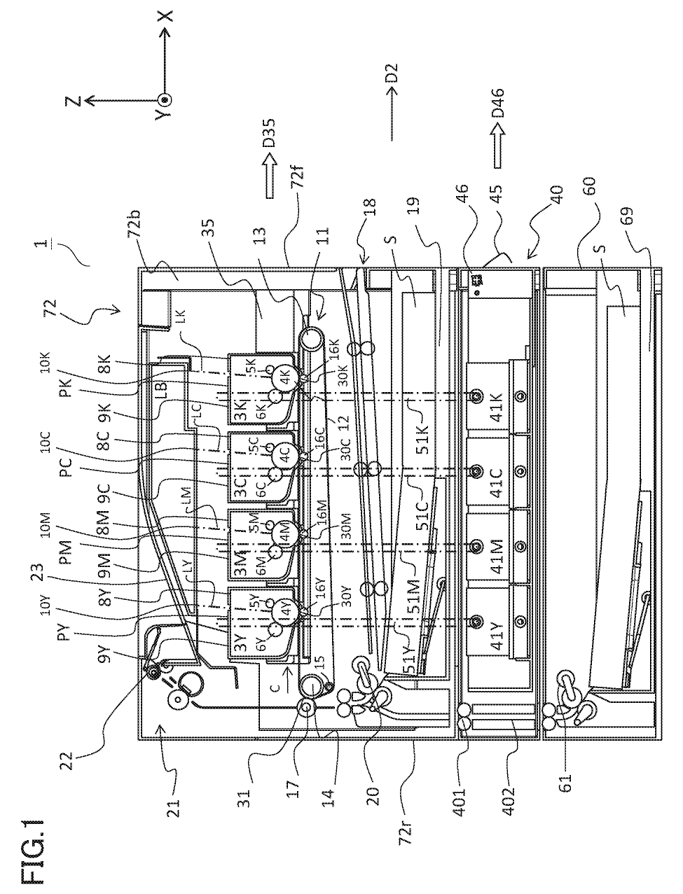

An image forming apparatus 1 according to an embodiment of the present disclosure will be described with reference to FIG. 1. FIG. 1 is a section view of the image forming apparatus 1.

The image forming apparatus 1 is a full-color laser printer that forms an image on a recording material S by an electrophotographic process by using toners of four colors. As the recording material S (recording medium), various sheet materials of different sizes and materials can be used. Examples of the various sheet materials include paper sheets such as plain paper sheets and cardboards, surface-treated sheet materials such as coated paper sheets, sheet materials of irregular shapes such as envelopes and index paper sheets, plastic films, and cloths.

As illustrated in FIG. 1, the image forming apparatus 1 includes process units PY, PM, PC, and PK, and a main body 72. The process units PY, PM, PC, and PK respectively use yellow, magenta, cyan, and black toners. The process units PY, PM, PC, and PK can be respectively referred to as a first process unit, a second process unit, a third process unit, and a fourth process unit.

In the description below, in the case where a plurality of units or members are provided in correspondence with the toners of four colors, the reference sign Y/M/C/K may be omitted in the case of mentioning arbitrary one of the units and members. For example, in the present embodiment, “process unit P” indicates arbitrary one of the four process units PY, PM, PC, and PK.

In the description below and the drawings, the vertical direction (gravity direction) in the case where the image forming apparatus 1 is placed on a horizontal surface will be referred to as a Z-axis direction. The direction of the rotation axis of a photosensitive drum (image bearing member) included in the image forming apparatus 1 will be referred to as a Y-axis direction. A direction orthogonal to both the Z-axis direction and the Y-axis direction will be referred to as an X-axis direction. The X-axis direction, the Y-axis direction, and the Z-axis direction may preferably be orthogonal to each other. In addition, the positive directions and the negative directions of the directions along the respective coordinate axes will be expressed with + (plus) or - (minus) signs if necessary. For example, the positive direction of the X axis (direction indicated by an arrow X in the drawings) will be referred to as a +X direction, and the negative direction (direction opposite to the direction indicated by an arrow X in the drawings) of the X axis will be referred to as a -X direction.

The process units PY, PM, PC, and PK respectively include drum units 8Y, 8M, 8C, and 8K, and developing units 9Y, 9M, 9C, and 9K. In other words, each process unit P includes a drum unit 8 and a developing unit 9.

As illustrated in FIG. 1, the drum units 8Y, 8M, 8C, and 8K respectively include photosensitive drums 4Y, 4M, 4C, and 4K, and charging rollers 5Y, 5M, 5C, and 5K. Each photosensitive drum 4 is an electrophotographic photosensitive member in which, for example, a photosensitive layer is formed from an organic photosensitive material on the outer peripheral portion of a conductive base body having a cylindrical shape. Each photosensitive drum 4 and each charging roller 5 rotate about a rotation axis extending in the Y-axis direction. The photosensitive drums 4Y, 4M, 4C, and 4K can be respectively referred to as a first photosensitive drum, a second photosensitive drum, a third photosensitive drum, and a fourth photosensitive drum.

The developing units 9Y, 9M, 9C, and 9K respectively include developing rollers 6Y, 6M, 6C, and 6K, and developing containers 3Y, 3M, 3C, and 3K. Each developing container 3 stores toner serving as a developer. Each developing roller 6 rotates about a rotation axis extending in the Y-axis direction.

The developing units 9Y, 9M, 9C, and 9K can be respectively referred to as a first developing unit, a second developing unit, a third developing unit, and a fourth developing unit. The developing rollers 6Y, 6M, 6C, and 6K can be respectively referred to as a first developing roller, a second developing roller, a third developing roller, and a fourth developing roller. The developing containers 3Y, 3M, 3C, and 3K can be respectively referred to as a first developing container, a second developing container, a third developing container, and a fourth developing container.

To be noted, the ordinal numbers first to fourth in the description of the present embodiment are selected arbitrarily. For example, the magenta developing unit 9M and the magenta developing container 3M may be referred to as a first developing unit and a first developing container, and the black developing unit 9K and the black developing container 3K may be referred to as a second developing unit and a second developing container.

Each developing roller 6 is configured to rotate while bearing toner stored in corresponding one of the developing containers 3 and supply the toner to corresponding one of the photosensitive drums 4. That is, the developing container 3Y stores yellow (Y) toner, and the developing roller 6Y bears and supplies the yellow toner in the developing container 3Y to the surface of the photosensitive drum 4Y. The developing container 3M stores magenta (M) toner, and the developing roller 6M bears and supplies the magenta toner in the developing container 3M to the surface of the photosensitive drum 4M. The developing container 3C stores cyan (C) toner, and the developing roller 6C bears and supplies the cyan toner in the developing container 3C to the surface of the photosensitive drum 4C. The developing container 3K stores black (K) toner, and the developing roller 6K bears and supplies the black toner in the developing container 3K to the surface of the photosensitive drum 4K.

Yellow toner is an example of first toner, magenta toner is an example of second toner, cyan toner is an example of third toner, and black toner is an example of fourth toner. To be noted, the ordinal numbers first to fourth are selected arbitrarily. In addition, the number of the process units P included in the image forming apparatus 1 and the number and combination of colors of toner used for image formation are changeable.

Each charging roller 5 functions as a charging member that charges the photosensitive drum 4. Each developing roller 6 functions as a developing member that develops a latent image on the photosensitive drum 4 by using developer. The charging roller 5 and the developing roller 6 are each a process element that acts on the photosensitive drum 4 to execute a step of an electrophotographic process.

To be noted, in image formation, the photosensitive drum 4 and the like are rotationally driven by a driving force transmitted to the process unit P from a drive source provided in the main body 72. In addition, in image formation, a bias voltage is applied to the charging roller 5 and the developing roller 6 supplied to the process unit P from a high-voltage board provided in the main body 72.

Further, the main body 72 includes a laser scanner unit LB serving as an exposing unit includes an intermediate transfer unit 11, a secondary transfer roller 17, a feeding unit 18, a fixing unit 21, and a discharge roller 22. In addition, a process unit tray 35 and a toner cartridge tray 46 are movably attached to the main body 72. The process unit tray 35 and the toner cartridge tray 46 will be described later.

The laser scanner unit LB is disposed above the process units PY to PK in the Z-axis direction. The laser scanner unit LB includes a light source (laser light source) that emits light for exposing the photosensitive drums 4, and a scanning optical system for guiding the light to the photosensitive drums 4Y to 4K.

The optical paths of the laser light from the laser scanner unit LB to the photosensitive drums 4Y, 4M, 4C, and 4K will be respectively denoted by LY, LM, LC, and LK. Exposing windows 10Y, 10M, 10C, and 10Kthat are transparent members (or opening portions) respectively constituting part of the optical paths LY, LM, LC, and LK are provided in the casing of the laser scanner unit LB. To be noted, as the exposing unit, a light emitting diode (LED) exposing unit including an LED element may be used instead of the laser light source.

The intermediate transfer unit 11 is disposed below the process units P in the Z-axis direction. The intermediate transfer unit 11 includes a transfer belt 12 (intermediate transfer belt), a driving roller 14, a tension roller 13, an assist roller 15, and primary transfer rollers 16Y, 16M, 16C, and 16K. The transfer belt 12 is an endless member having flexibility, and is stretched over the driving roller 14, the tension roller 13, and the assist roller 15.

Each photosensitive drum 4 is disposed such that the surface thereof is in contact with the outer surface of the transfer belt 12. The contact portions between the transfer belt 12 and the photosensitive drums 4Y, 4M, 4C, and 4K are respectively primary transfer portions 30Y, 30M, 30C, and 30K. The primary transfer rollers 16 are each disposed in an inner space of the transfer belt 12, and each oppose corresponding one of the photosensitive drums 4 with the transfer belt 12 therebetween.

The secondary transfer roller 17 is pressed toward the driving roller 14 with the transfer belt 12 therebetween. The contact portion between the transfer belt 12 and the secondary transfer roller 17 is a secondary transfer portion 31. The secondary transfer portion 31 is a transfer portion where a toner image is transferred onto a recording material S.

The feeding unit 18 is provided below the intermediate transfer unit 11 in the Z-axis direction. The feeding unit 18 includes a feed tray 19 (sheet stacking portion, cassette) in which the recording material S is stacked and accommodated, and a feed roller 20 serving as a feeding member that feeds the recording material S from the feed tray 19. In addition, the feeding unit 18 includes a separation roller pair that conveys the recording materials S fed from the feed tray 19 one by one while separating the recording materials S from each other by a frictional force.

The fixing unit 21 is provided above the secondary transfer portion 31 in the Z-axis direction. The fixing unit 21 includes a rotary member pair that rotates while nipping the recording material S, and a heating means that heats the toner image on the recording material S. The rotary member constituting the rotary member pair is a cylindrical roller, a tubular film, a belt stretched over a plurality of rollers, or the like. In addition, the heating means is a halogen lamp, a ceramic heater in which a pattern of a heat-generating resistor is formed on a ceramic substrate, a coil for induction heating, or the like.

The discharge roller 22 is a discharge member that discharges the recording material S to the outside of the main body 72. A discharge tray 23 on which the recording material S is to be stacked is provided on the top surface of the main body 72.

The discharge roller 22 of the present embodiment discharges the recording material S toward one side (+X side) in the X-axis direction. In the present embodiment, the downstream side (+X side) in a discharge direction in which the recording material S is discharged toward the discharge tray 23 by the discharge roller 22 may be referred to as the front side of the image forming apparatus 1, and the opposite side thereto (-X side) may be referred to as the rear side of the image forming apparatus 1.

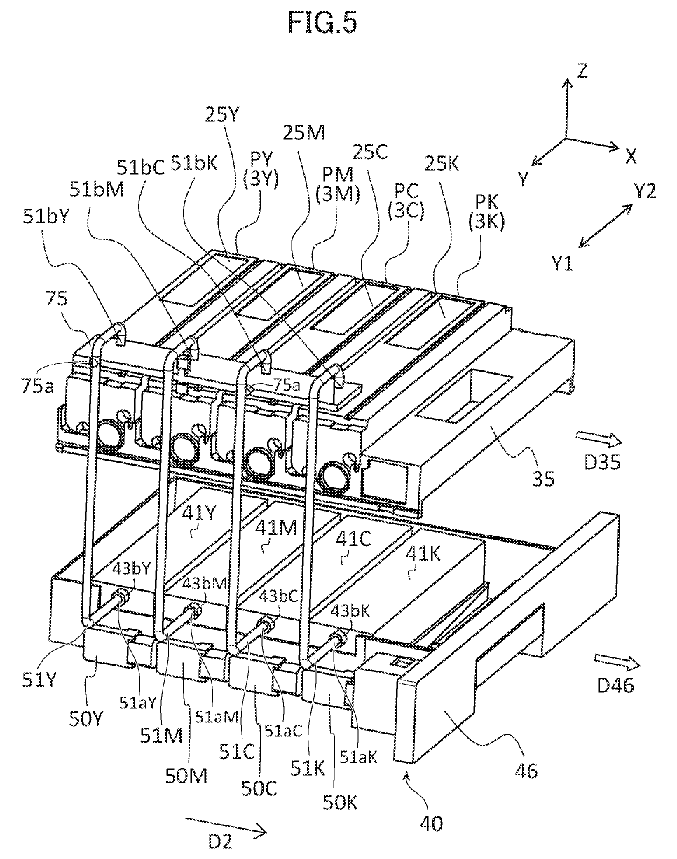

In addition, the image forming apparatus 1 includes a toner replenishment unit 40, and toner passages 51Y, 51M, 51C, and 51K. The toner replenishment unit 40 is provided below the feeding unit 18 in the Z-axis direction. The toner replenishment unit 40 includes a toner cartridge try 46, toner cartridges 41Y, 41M, 41C, and 41K attachable to and detachable from the toner cartridge tray 46, and pump units 50Y, 50M, 50C, and 50K (see also FIG. 5).

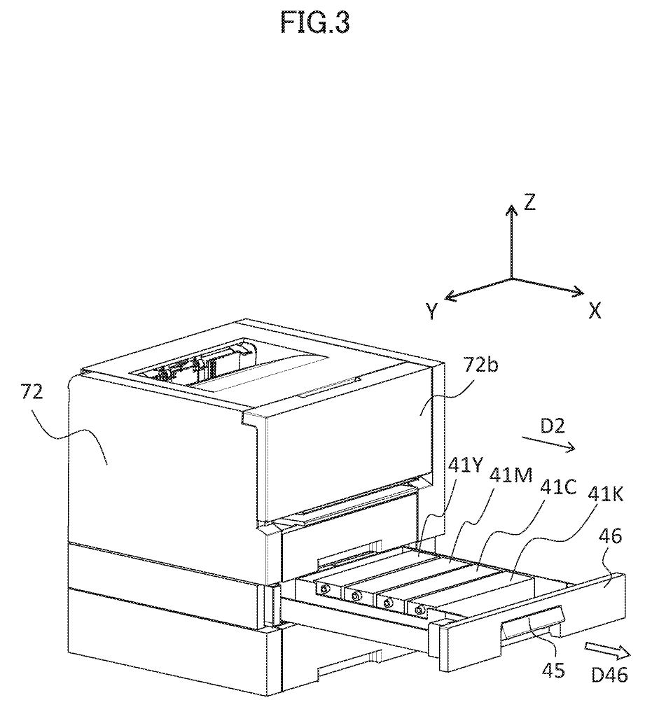

The toner cartridge tray 46 is supported by the main body 72, and is provided such that the toner cartridge tray 46 can be drawn out toward the front side of the image forming apparatus 1. In other words, the toner cartridge tray 46 is movably attached to the main body 72. The toner cartridge tray 46 is movable to an accommodated position (FIG. 1) where the toner cartridge tray 46 is accommodated in the main body 72, and a replacement position (FIG. 3) where the toner cartridge tray 46 is drawn out to the outside of the main body 72. The accommodated position is an inner position where the toner cartridges 41Y, 41M, 41C, and 41K are inside the main body 72. The replacement position is an outer position where the toner cartridges 41Y, 41M, 41C, and 41K are exposed to the outside of the main body 72.

Each toner cartridge 41 moves with respect to the main body 72 in a state of being supported by the toner cartridge tray 46 serving as a support member (first support member). Each toner cartridge 41 is attachable to and detachable from the main body 72 by attachment and detachment to and from the toner cartridge tray 46.

The toner cartridge 41Y stores yellow toner to replenish the developing container 3Y. The toner cartridge 41M stores magenta toner to replenish the developing container 3M. The toner cartridge 41C stores cyan toner to replenish the developing container 3C. The toner cartridge 41K stores black toner to replenish the developing container 3K. The toner stored in each toner cartridge 41 is supplied to corresponding one of the developing containers 3 through corresponding one of the toner passages 51 as will be described later.

The toner cartridges 41Y, 41M, 41C, and 41K can be respectively referred to as a first cartridge (first toner container), a second cartridge (second toner container), a third cartridge (third toner container), and a fourth cartridge (fourth toner container). Each toner cartridge 41 is configured to discharge toner by air supplied from corresponding one of pump units 50.

The toner passages 51Y to 51K are respectively provided in correspondence with the toner cartridges 41Y to 41K. Each toner passage 51 communicates with both corresponding one of the toner cartridges 41 and corresponding one of the developing containers 3, and constitutes a passage in which toner is conveyed from the toner cartridge 41 toward the developing container 3 by air. Each toner passage 51 is formed from, for example, a tubular resin member having flexibility.

The toner passage 51Y is an example of a first passage that communicates with the toner cartridge 41Y and the developing container 3Y and that the yellow toner (first toner) discharged from the toner cartridge 41Y passes through when conveyed by air to the developing container 3Y. The toner passage 51M is an example of a second passage that communicates with the toner cartridge 41M and the developing container 3M and that the magenta toner (second toner) discharged from the toner cartridge 41M passes through when conveyed by air to the developing container 3M. The toner passage 51C is an example of a third passage that communicates with the toner cartridge 41C and the developing container 3C and that the cyan toner (third toner) discharged from the toner cartridge 41C passes through when conveyed by air to the developing container 3C. The toner passage 51K is an example of a fourth passage that communicates with the toner cartridge 41K and the developing container 3K and that the black toner (fourth toner) discharged from the toner cartridge 41K passes through when conveyed by air to the developing container 3K.

### Arrangement of Developing Unit

The direction of the rotation axis of the developing roller 6Y will be referred to as a first direction. The first direction of the present embodiment is the Y-axis direction. A direction intersecting with both the gravity direction (Z-axis direction) and the first direction will be referred to as a second direction. The second direction in the present embodiment is the X-axis direction orthogonal to both the Z-axis direction and the Y-axis direction. A front direction D2 illustrated in FIG. 1 and the like is a direction following the second direction, and is a direction from one end (rear surface 72r) toward the other end (front surface 72f) of the main body 72 in the second direction.

The process units PY, PM, PC, and PK of the present embodiment are aligned in the X-axis direction (second direction). The process units PY, PM, PC, and PK of the present embodiment are arranged in this order in the front direction D2. In addition, the developing units 9Y, 9M, 9C, and 9K of the present embodiment are aligned in the X-axis direction (second direction). The developing units 9Y, 9M, 9C, and 9K are arranged in this order in the front direction D2. In addition, the developing containers 3Y, 3M, 3C, and 3K (first developing container, second developing container, third developing container, and fourth developing container) of the present embodiment are aligned in the X-axis direction (second direction), and are arranged in this order in the front direction D2.

As viewed in the X-axis direction (second direction), the developing container 3Y may preferably overlap the developing container 3M, the developing container 3M may preferably overlap the developing container 3C, and the developing container 3C may preferably overlap the developing container 3K. As viewed in the X-axis direction (second direction), the four developing containers 3Y, 3M, 3C, and 3K may be in a positional relationship to overlap each other.

### Toner Replenishment Unit

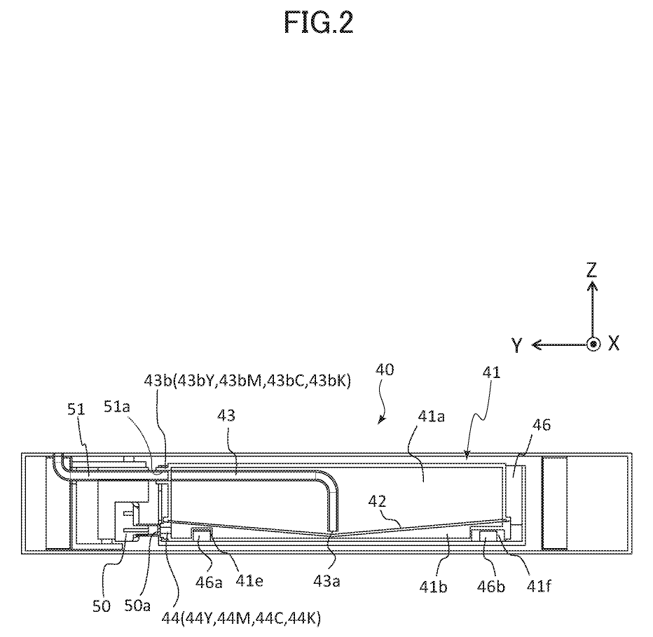

The toner replenishment unit 40 will be described with reference to FIGS. 2 and 3. FIG. 2 is a section view of the toner replenishment unit 40 as viewed in a direction orthogonal to FIG. 1. FIG. 3 is a perspective view of the image forming apparatus 1 in a state in which the toner cartridge tray 46 is drawn out. To be noted, although FIG. 2 illustrates a cross-section passing through arbitrary one of the toner cartridges 41, substantially the same as FIG. 2 applies to cross-sections passing through other toner cartridges 41.

As illustrated in FIG. 2, each toner cartridge 41 includes a toner chamber 41a storing toner, an air chamber 41b communicating with the outside of the toner cartridge 41, and a filter 42 partitioning the toner chamber 41a and the air chamber 41b.

The filter 42 is formed from a breathable material (for example, an unwoven fabric) that allows passage of air and hinders passage of toner. The toner chamber 41a is provided with a toner path 43 (toner flow path, pipe). One end of the toner path 43 is a toner intake port 43a opening in the toner chamber 41a, and the other end of the toner path 43 is a toner discharge port 43b opening to the outside of the toner cartridge 41 (outside of the toner chamber 41a). The toner cartridge 41 is provided with an air intake port 44 for taking in air. The air intake port 44 communicates with the air chamber 41b and is open to the outside of the toner cartridge 41.

The air intake ports 44Y, 44M, 44C, and 44K respectively provided in the toner cartridges 41Y, 41M, 41C, and 41K can be respectively referred to as a first intake port, a second intake port, a third intake port, and a fourth intake port. The toner discharge ports 43bY, 43bM, 43bC, and 43bK respectively provided in the toner cartridges 41Y, 41M, 41C, and 41K can be respectively referred to as a first discharge port, a second discharge port, a third discharge port, and a fourth discharge port.

When performing toner replenishment by using the toner cartridge 41, air is supplied to the air intake port 44 of the toner cartridge 41 from corresponding one of the pump units 50, and air is taken into the air chamber 41b through the air intake port 44. The air having flowed into the air chamber 41b flows into the toner chamber 41a through the filter 42. Then, the air having flowed in mixes with the toner in the toner chamber 41a, and thus the toner is fluidized. In addition, the internal pressure in the toner chamber 41a increases, and thus the air and the toner flow into the toner path 43 through the toner intake port 43a. The air and toner discharged to the outside of the toner cartridge 41 through the toner discharge port 43b is supplied to corresponding one of the developing containers 3 through the toner passage 51.

The toner cartridge tray 46 is a holding member holding each toner cartridge 41 (support member supporting the toner cartridge 41). As illustrated in FIG. 2, the toner cartridge tray 46 includes first positioning portions 46a and second positioning portions 46b for positioning the toner cartridges 41. The toner cartridges 41 are each provided with a first engaged portion 41e and a second engaged portion 41f respectively engaged with the first positioning portion 46a and the second positioning portion 46b.

As illustrated in FIG. 3, the toner cartridge tray 46 includes a handle portion 45 (grip portion). The user can draw out the toner cartridge tray 46 in the front direction of the image forming apparatus 1 from the frame body of the main body 72 by gripping the handle portion 45. That is, a draw-out direction D46 of the toner cartridge tray 46 in the present embodiment is a direction following the X-axis direction (second direction). The draw-out direction D46 of the toner cartridge tray 46 may be parallel to the X-axis direction (second direction).

When the toner cartridge tray 46 is drawn out in the front direction D2, each toner cartridge 41 is drawn out from the main body 72 together with the toner cartridge tray 46. The user can replace each toner cartridge 41 by accessing the toner cartridge 41 from above in a state in which the toner cartridge tray 46 is drawn out. That is, each toner cartridge 41 can be separated upward from the toner cartridge tray 46 drawn out to the outside of the main body 72, and a new toner cartridge 41 can be attached to the toner cartridge tray 46 from the upper side to the lower side.

As described above, according to the configuration in which the toner cartridge 41 is attached to and detached from the toner cartridge tray 46 that can be drawn out from the main body 72, the replacement of the toner cartridge 41 can be facilitated. In addition, the draw-out direction D46 of the toner cartridge tray 46 is the front direction of the image forming apparatus 1 similarly to the discharge direction to the discharge tray 23 and the draw-out direction of the feed tray 19, and therefore can contribute to improvement in the overall operability of the image forming apparatus 1.

To be noted, the image forming apparatus 1 of the present embodiment includes an optional feeder unit 60 (FIG. 1) coupled to the lower side of the toner replenishment unit 40. The optional feeder unit 60 includes a feed tray 69 in which the recording material S is stacked and stored, and a feeding roller 61 that feeds the recording material S from the feed tray 69. The toner replenishment unit 40 includes a conveyance guide 402 constituting a relay conveyance path that receives the recording material S fed from the optional feeder unit 60 and a conveyance roller 401 that conveys the recording material S passing through the relay conveyance path to the main body 72.

### Positional Relationship between Toner Cartridge and Developing Unit

The arrangement of the toner cartridges 41Y to 41K will be described. The toner cartridges 41Y, 41M, 41C, and 41K are respectively disposed below the developing units 9Y, 9M, 9C, and 9K in the Z-axis direction (gravity direction). That is, it can be said that the first toner container and the second toner container are respectively disposed below the first developing unit and the second developing unit in the gravity direction.

According to this configuration, the capacity of the toner cartridges 41Y to 41K can be increased by using the space below the developing units 9Y to 9K. In addition, for example, by disposing the toner cartridges 41Y to 41K further below the feeding unit 18, the capacity of the toner cartridges 41 can be increased without the restriction in the accommodation space and conveyance path of the recording material S. In addition, since the toner is supplied from each toner cartridge 41 to corresponding one of the developing containers 3 by air in the present embodiment, the conveyance of toner is not likely to be interrupted even if the toner cartridges 41 are positioned below the developing containers 3.

The toner cartridges 41Y, 41M, 41C, and 41K are aligned in the X-axis direction (second direction). The toner cartridges 41Y, 41M, 41C, and 41K are arranged in this order in the front direction D2. In other words, the first toner container and the second toner container are aligned in the second direction. In addition, the toner cartridges 41Y, 41M, 41C, and 41K are arranged in the X-axis direction (second direction) in the same order as the developing units 9Y, 9M, 9C, and 9K respectively corresponding thereto. By employing the consistent arrangement order as described above, the arrangement of the toner cartridges 41Y to 41K and the process units PY to PK is intuitively understandable, and thus good usability can be obtained.

In the present embodiment, the draw-out direction D46 of the toner cartridge tray 46 supporting the toner cartridges 41 and a draw-out direction D35 of the process unit tray 35 supporting the process units P are each a direction following the front direction D2. It can be said that the order of arrangement of the toner cartridges 41Y, 41M, 41C, and 41K in the draw-out direction D46 of the toner cartridge tray 46 is the same as the order of arrangement of the process units PY, PM, PC, and PK in the draw-out direction D35 of the process unit tray 35. By employing the consistent arrangement order as described above, the arrangement of the toner cartridges 41Y to 41K and the process units PY to PK is intuitively understandable, and thus the usability in the case of replacement each toner cartridge 41 or each process unit P can be improved.

In addition, as illustrated in FIG. 5, each toner cartridge 41 has a shape elongated in the Y-axis direction. That is, the length of each toner cartridge 41 in the Y-axis direction (first direction) is larger than the length of the toner cartridge 41 in a direction orthogonal to the Y-axis direction. In other words, the longitudinal direction of each toner cartridge 41 is approximately parallel to the longitudinal direction of corresponding one of the developing containers 3. As described above, by aligning the toner cartridges 41Y to 41K elongated in the Y-axis direction in the X-axis direction (second direction) in a similar manner to the developing containers 3Y to 3K, the space can be used efficiently.

In the present embodiment, each toner cartridge 41 may be disposed at a position below corresponding one of the developing units 9 and overlapping the developing unit 9 as viewed in the gravity direction (Z-axis direction). In other words, as viewed in the gravity direction, the first developing unit overlaps the first toner container, and the second developing unit overlaps the second toner container. This arrangement is advantageous in increasing the capacity of the toner cartridge 41 (toner container) by using the space below the developing unit.

Particularly, as viewed in the gravity direction (Z-axis direction), each developing container 3 may overlap corresponding one of the toner cartridges 41. That is, the first developing unit may overlap the first toner container, and the second developing unit may overlap the second toner container. More specifically, as viewed in the gravity direction (Z-axis direction), the toner storage space in each developing container 3 may overlap the toner storage space (toner chamber 41a) in corresponding one of the toner cartridges 41.

Here, two elements “overlapping each other as viewed in a predetermined direction” indicates that the projection area of one element overlaps the projection area of the other element at least partially in the case where each element is orthogonally projected onto a virtual plane orthogonal to the predetermined direction.

### Case Other than Air Conveyance System

In the present embodiment, a configuration of an air conveyance system in which toner is conveyed from the toner cartridges 41Yto 41K to the developing units 9Yto 9K by the air supplied from the pump units 50Y to 50K serving as air supplying portions. However, the arrangement of the toner cartridges and developing units described in the present embodiment may be applied to an image forming apparatus other than an air conveyance system. That is, the arrangement of the toner cartridges 41Yto 41Kand the developing units 9Y to 9Kdescribed in the present embodiment may be combined with a conveyance mechanism that conveys toner from each toner cartridge 41 to corresponding one of the developing containers 3 by a conveyance member such as a screw. As a result of this, the advantage (other than advantage requiring the air conveyance system) obtained from the arrangement of the toner cartridges 41Yto 41K and the developing units 9Yto 9K described in the present embodiment can be obtained.

According to the present embodiment, the developing units 9Y to 9K attached to the process unit tray 35 are aligned in the X-axis direction (second direction), and the toner cartridges 41Y to 41K are aligned in the X-axis direction (second direction) in a space below the developing units 9Y to 9K. That is, the first developing unit and the second developing unit are attached to the process unit tray 35 as moving units movable in the X-axis direction (second direction). The first toner container and the second toner container are aligned in the X-axis direction (second direction), and are disposed below the first developing unit and the second developing unit in the gravity direction. As described above, a new configuration related to an arrangement of the toner containers storing toner for replenishment in an image forming apparatus is provided.

In addition, according to the present embodiment, the developing units 9Y to 9K are aligned in the X-axis direction (second direction), and the toner cartridges 41Y to 41K attachable to and detachable from the toner cartridge tray 46 are aligned in the X-axis direction (second direction) in a space below the developing units 9Y to 9K. That is, the first toner container and the second toner container are attached to the toner cartridge tray 46 serving as a movable unit movable in the X-axis direction (second direction). The first toner container and the second toner container are aligned in the X-axis direction (second direction), and are disposed below the first developing unit and the second developing unit in the gravity direction. As described above, a new configuration related to an arrangement of the toner containers storing toner for replenishment in an image forming apparatus is provided.

### Image Forming Operation

The image forming operation executed by the image forming apparatus 1 will be described with reference to FIG. 1. The image forming operation is a series of operation in which the image forming apparatus 1 forms an image on the recording material S while conveying the recording material S. The controller of the image forming apparatus 1 starts the image forming operation in the case where, for example, an instruction to execute image formation is received from an external computer together with image information.

When the image forming operation is started, the photosensitive drums 4 are rotationally driven at a predetermined peripheral speed (process speed) in a counterclockwise direction in the drawings. The transfer belt 12 is rotationally driven at a speed corresponding to the peripheral speed of each photosensitive drum 4 in a rotation direction (arrow C direction in drawings) following the rotation of each photosensitive drum 4.

The controller drives the laser scanner unit LB on the basis of the image signals obtained by dividing the image information into components of respective colors. In each process unit P, the charging roller 5 uniformly charges the surface of corresponding one of the photosensitive drums 4 to a predetermined polarity and potential in synchronization with the driving of the laser scanner unit LB. The laser scanner unit LB exposes the surface of each charged photosensitive drum 4 by scanning the surface with laser light, and thus forms an electrostatic latent image corresponding to the image signal of each color on the surface of each photosensitive drum 4.

The electrostatic latent image on the photosensitive drum 4 is developed by toner supply to the photosensitive drum 4 from the developing roller 6 rotationally driven in a clockwise direction in the drawings at a predetermined speed. As a result of this, a yellow toner image is formed on the photosensitive drum 4Y, and the yellow toner image is transferred onto the transfer belt 12 at the primary transfer portion 30Y. Similarly, magenta, cyan, and black toner images are respectively formed on the photosensitive drums 4M, 4C, and 4K. These toner images are transferred through primary transfer so as to be superimposed on the yellow toner image on the transfer belt 12 respectively at the primary transfer portions 30M, 30C, and 30K. In this manner, a full-color toner image is formed on the transfer belt 12.

In parallel with the formation of the toner image by the process units PY to PK and the intermediate transfer unit 11, the recording material S is fed at a predetermined timing by the feed roller 20 or 61 of the feeding unit 18 or the optional feeder unit 60. The recording material S that has been fed is conveyed to the secondary transfer portion 31 at a timing when the toner image formed on the transfer belt 12 reaches the secondary transfer portion 31. Then, while the recording material S passes the secondary transfer portion 31, the toner image is transferred from the transfer belt 12 onto the recording material S (secondary transfer).

The recording material S having passed the secondary transfer portion 31 is conveyed to the fixing unit 21. The fixing unit 21 heats and pressurizes the toner image on the recording material S while nipping and conveying the recording material S in the nip portion (fixing nip) of the rotary member pair, and thus fixes the toner image to the recording material S. The recording material S having passed the fixing unit 21 is discharged onto the discharge tray 23 by the discharge roller 22.

### Replacement of Process Unit

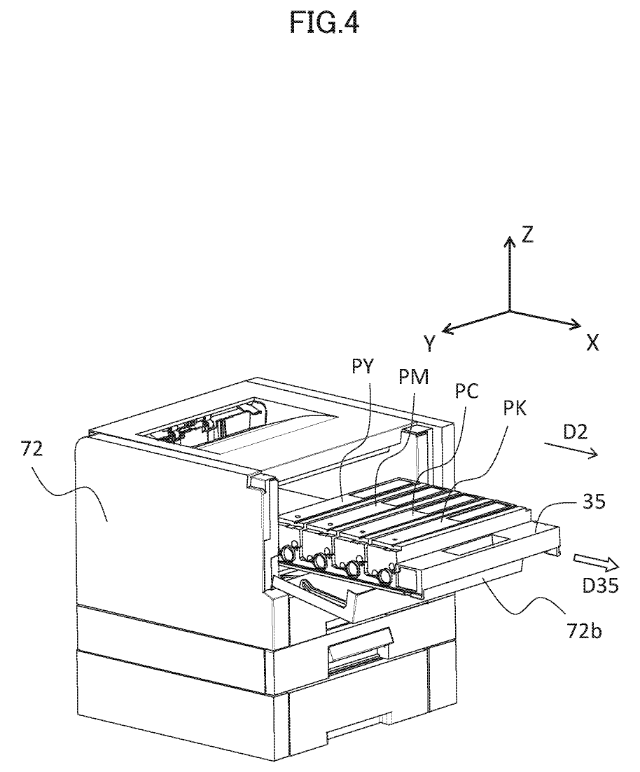

The configuration related to replacement of the process unit P will be described with reference o FIG. 4. FIG. 4 is a perspective view of the image forming apparatus 1 in a state in which the process unit tray 35 has been drawn out.

As illustrated in FIG. 4, the main body 72 includes a front door 72b serving as an opening/closing member movable between a closed position (see FIG. 1) where the front door 72b closes the opening of the main body 72 on the front side and an open position (see FIG. 4) where the front door 72b opens the opening.

The process unit tray 35 is movable to an accommodated position (inner position, FIG. 1) where the process unit tray 35 is accommodated in the main body 72, and a replacement position (outer position, FIG. 4) where the process unit tray 35 is drawn out to the outside of the main body 72. The accommodated position is an inner position where the developing units 9Y, 9M, 9C, and 9K are in the main body 72. The replacement position is an outer position where the developing units 9Y, 9M, 9C, and 9K are exposed to the outside of the main body 72.

The process unit tray 35 in the present embodiment is an example of a moving unit that the first developing unit and the second developing unit are attachable to and detachable from and that is movable between the inner position and the outer position with respect to the main body in a state in which the first developing unit and the second developing unit are attached thereto. To be noted, the toner cartridge tray 46 in the present embodiment is an example of a moving unit that the first toner container and the second toner container are attachable to and detachable from and that is movable between the inner position and the outer position with respect to the main body in a state in which the first toner container and the second toner container are attached thereto. In the case where the process unit tray 35 is referred to as a first moving unit movable between a first inner position and a first outer position, the toner cartridge tray 46 can be referred to as a second moving unit movable between a second inner position and a second outer position.

The process unit tray 35 is configured such that the process unit tray 35 can be drawn out from the main body 72 in the front direction in a state in which the front door 72b is at the open position as illustrated in FIG. 4. That is, the draw-out direction D35 of the process unit tray 35 in the present embodiment is a direction following the X-axis direction (second direction) described above. The draw-out direction D35 of the process unit tray 35 may be the same direction as the X-axis direction, that is, may be parallel to the X-axis direction.

In the present embodiment, each process unit P is configured as a cartridge (process cartridge) that is attachable to and detachable from the main body 72. The process cartridge is a unit including a photosensitive drum and at least one process element that acts on the photosensitive drum, and attachable to and detachable from the main body of the image forming apparatus.

Each process unit P of the present embodiment moves with respect to the main body 72 in the state of being supported by the process unit tray 35 serving as a support member (second support member). Each process unit P can be attached to and detached from the main body 72 by attachment to and detachment from the process unit tray 35.

To be noted, each developing unit 9 may be configured to be attached to and detached from the process unit tray 35 independently from corresponding one of the drum units 8. In addition, each drum unit 8 may be configured as part of the process unit tray 35, and each developing unit 9 may be attached to and detached from the process unit tray 35 including the photosensitive drums 4.

In a state in which the front door 72b is open and the process unit tray 35 is drawn out to the outside of the main body 72, the user can access each process unit P from above and replace the process unit P. That is, the process unit P can be detached upward from the process unit tray 35 drawn out to the outside of the main body 72, and a new process unit P can be attached to the process unit tray 35 from the upper side toward the lower side.

### Toner Replenishment Path

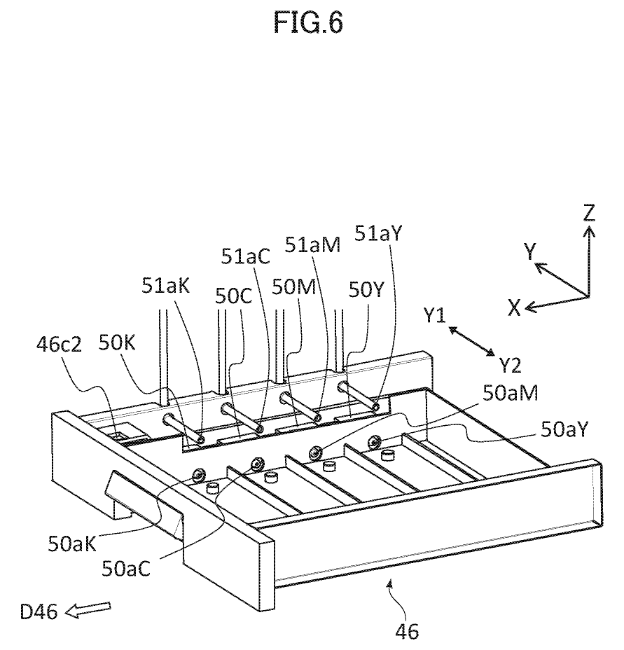

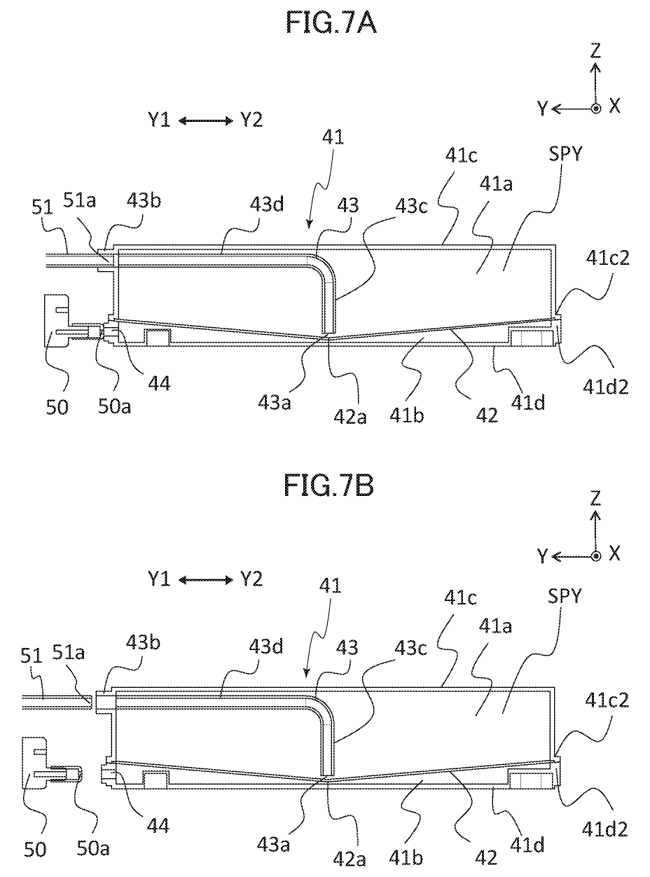

A toner replenishment path (toner conveyance path) from each toner cartridge 41 to corresponding one of the developing units 9 will be described with reference to FIGS. 5, 6, and 7A. FIG. 5 is a perspective view illustrating the toner replenishment unit 40 to which the toner cartridges 41Y to 41K are attached, the process units PY to PK attached to the process unit tray 35, and toner passages 51Y to 51K. FIG. 6 is a perspective view of the toner replenishment unit 40 in a state in which the toner cartridges 41Y to 41K are detached. FIG. 7A is a section view of the toner cartridge 41 connected to the pump unit 50 and the toner passage 51.

As illustrated in FIGS. 5, 6, and 7A, each pump unit 50 is disposed to be aligned with corresponding one of the toner cartridges 41 in the Y-axis direction. In the Y-axis direction, a direction from the toner cartridge 41 toward the pump unit 50 will be referred to as a Y1 direction, and a direction from the pump unit 50 toward the toner cartridge 41 will be referred to as a Y2 direction.

The pump units 50Y, 50M, 50C, and 50K are aligned in the X-axis direction (second direction) described above. The pump units 50Y, 50M, 50C, and 50Kare arranged in this order in the front direction D2. The pump units 50Y, 50M, 50C, and 50K can be respectively referred to as a first pump unit (first pump), a second pump unit (second pump), a third pump unit (third pump), and a fourth pump unit (fourth pump).

As each pump unit 50, a displacement pump such as a reciprocating pump or a rotary pump can be used. The reciprocating pump is a pump that performs suction and ejection by a reciprocating motion of a piston, a plunger, or the like, and examples thereof include a piston pump, a plunger pump, and a diaphragm pump. The rotary pump is a pump that performs suction and ejection by a rotary motion of a gear, a rotor, or the like, and examples thereof include a gear pump, a screw pump, and a vane pump. In the present embodiment, for example, a diaphragm pump is used.

The pump units 50Y to 50K are each an example of an air supplying portion that supplies air for performing replenishment of toner from each toner cartridge 41 to the corresponding one of developing container 3 by air. To be noted, four pump units 50Yto 50K that respectively supply air to four toner cartridges 41Y to 41K are provided in the present embodiment, but one pump unit 50 may supply air to two or more toner cartridges 41. For example, a configuration in which a valve is added to a path interconnecting one pump unit 50 and two or more toner cartridges 41, and air supply to each toner cartridge 41 can be blocked (controlled) independently from each other may be employed. In this case, an air supplying portion is constituted by one pump unit 50 and a valve.

In addition, although the pump unit 50 of the present embodiment is provided in the main body 72, the pump unit 50 may be provided in the toner cartridge 41.

In addition, in the present embodiment, from each toner cartridge 41 to corresponding one of the developing containers 3, toner is conveyed through corresponding one of the toner passages 51 by the air discharged together with the toner from the toner cartridge 41. That is, in the present embodiment, the pump unit 50 (air supplying portion), the toner cartridge 41, the toner passage 51, and the developing container 3 are arranged in this order from the upstream side toward the downstream side in a direction in which the air flows. The configuration is not limited to this, and for example, a pump unit may be provided instead of (or additionally to) the pump unit 50 of the present embodiment on the downstream side of the toner cartridge 41 in the direction in which the air flows.

As illustrated in FIG. 6, the pump units 50Y, 50M, 50C, and 50K serving as air supplying portions respectively have outlet ports 50aY, 50aM, 50aC, and 50aK for discharging air. The outlet ports 50aY, 50aM, 50aC, and 50aK can be respectively referred to as a first outlet port, a second outlet port, a third outlet port, and a fourth outlet port. To be noted, the outlet port of the air supplying portion is not limited to an outlet port of the pump unit itself, and may be an exit of a passage (air supply pipe) which is connected to the pump unit and through which air can be discharged toward the toner cartridge 41. The toner cartridge tray 46 includes a wall portion opposing an end surface of each toner cartridge 41 on the Y1 direction side (pump unit 50 side), and an opening through which the outlet port 50a is exposed is formed in the wall portion. Each outlet port 50a faces the Y2 direction.

As illustrated in FIG. 5, the toner passage 51Y has a receiving port 51aY (upstream end portion) communicating with the toner discharge port 43bY of the toner cartridge 41Y, and a delivery port 51bY (downstream end portion) communicating with the developing container 3Y of the process unit PY. The toner passage 51M has a receiving port 51aM (upstream end portion) communicating with the toner discharge port 43bM of the toner cartridge 41M, and a delivery port 51bM (downstream end portion) communicating with the developing container 3M of the process unit PM. The toner passage 51C has a receiving port 51aC (upstream end portion) communicating with the toner discharge port 43bC of the toner cartridge 41C, and a delivery port 51bC (downstream end portion) communicating with the developing container 3C of the process unit PC. The toner passage 51K has a receiving port 51aK (upstream end portion) communicating with the toner discharge port 43bK of the toner cartridge 41K, and a delivery port 51bK (downstream end portion) communicating with the developing container 3K of the process unit PK. Each receiving port 51a faces in the Y2 direction (FIG. 6), and is connected to the toner discharge port 43b of corresponding one of the toner cartridges 41. In addition, the delivery port 51b of each toner passage 51 is connected to an end portion in the Y1 direction of corresponding one of the developing containers 3.

Filters 25Y, 25M, 25C, and 25K are respectively provided in the top surfaces of the developing containers 3Y, 3M, 3C, and 3K. Since not only toner but also air flows into each developing container 3 through the toner passage 51, the inner pressure of the developing container 3 is likely to increase. Therefore, in the present embodiment, as illustrated in FIG. 5, the filter 25 is provided in the top surface of the developing container 3. The filter 25 is, for example, an unwoven fabric attached to cover a through hole provided in the frame body of the developing container 3. The toner having flowed into the developing container 3 through the toner passage 51 remains in the developing container 3, and at least part of the air is discharged to the outside of the developing container 3 through the filter 25. As a result of this, the increase in the inner pressure of the developing container 3 is suppressed, and succeeding toner and air easily flow into the developing container 3 through the toner passage 51.

Each toner passage 51 is disposed on one end side (+Y side) of the main body 72 in the Y-axis direction. More specifically, in the Y-axis direction (first direction) that is the direction of the rotation axis of the developing roller 6, each toner passage 51 extends to a position below corresponding one of the developing containers 3 while passing through a position outside of corresponding one of the developing containers 3 and overlapping the corresponding one of the developing containers 3 as viewed in the Y-axis direction. As a result of this arrangement, the space at an end portion of the main body 72 can be efficiently used for arranging the toner passages 51 to not interfere with elements (process units P and the like) related to image formation and elements related to conveyance of the recording material S in the main body 72.

### Inner Structure of Cartridge

The inner structure of each toner cartridge 41 of the present embodiment will be described with reference to FIG. 7A. The toner cartridge 41 includes a first frame body 41c, a second frame body 41d, a filter 42, and a toner discharge port 43b.

The first frame body 41c and the second frame body 41d are each a member formed from resin, but may be formed from, for example, paper. A sealing member (sticker or shutter) capable of closing the toner discharge port 43b may be provided. In a state in which the toner cartridge 41 is not attached to the toner replenishment unit 40, the sealing member seals the toner discharge port 43b, and suppresses leakage of the toner stored in the toner cartridge 41 to the outside of the toner cartridge 41. When attaching the toner cartridge 41 to the toner replenishment unit 40, the sealing member is removed or moved, and thus the toner discharge port 43b is opened.

The first frame body 41c and the second frame body 41d respectively include a flange portion 41c2 and a flange portion 41d2. The flange portions 41c2 and 41d2 are welded to each other by ultrasonic welding, and thus an inner space SPY of the toner cartridge 41 is formed. To be noted, the flange portions 41c2 and 41d2 may be fixed to each other with an adhesive or a screw.

The filter 42 partitions the inner space SPY of the toner cartridge 41 into a toner chamber 41a and an air chamber 41b. That is, the air chamber 41b is adjacent to the toner chamber 41a with the filter 42 therebetween.

The toner chamber 41a is a space storing toner. The lower portion of the toner stored in the toner chamber 41a is supported by the filter 42. No toner is stored in the air chamber 41b. The filter 42 is constituted by, for example, a porous member formed from resin fiber, and the size and density of the pores thereof are selected so as to allow passage of air and hinder passage of toner. That is, the filter 42 is configured to allow passage of air and hinder passage of toner. The filter 42 is held by the first frame body 41c and the second frame body 41d by being nipped between the flange portion 41c2 of the first frame body 41c and the flange portion 41c of the second frame body 41d. The filter 42 includes an inclined portion that is inclined such that a position closer to a lowermost portion 42a thereof in the Y-axis direction is lower.

A toner path 43 is provided in the toner chamber 41a. The toner path 43 of the present embodiment is a tubular-shape member formed from resin, but may be formed from paper, rubber, or the like. The toner path 43 is a pathway that the toner stored in the toner chamber 41a passes through when being discharged to the outside of the toner cartridge 41. The toner path 43 includes a first portion 43c extending in the Z-axis direction and provided with the toner intake port 43a at a lower end thereof, and a second portion 43d provided with the toner discharge port 43b at an end portion thereof in the Y1 direction. The direction in which the first portion 43c extends and the direction in which the second portion 43d extends intersect with (or are orthogonal to) each other.

The toner intake port 43a is disposed to oppose the lowermost portion 42a of the filter 42 with a gap therebetween. The toner intake port 43a may preferably be close to the lowermost portion 42a of the filter 42. In the case where the remainder amount of toner in the toner chamber 41a is small, the toner fluidized by the air taken in through the air intake port 44 gathers near the lowermost portion 42a by moving along the inclination of the filter 42 described above. If the toner intake port 43a is in the vicinity of the lowermost portion 42a of the filter 42, the toner can be efficiently discharged to the outside of the toner cartridge 41 even in the case where the remainder amount of the toner is small.

The toner cartridge 41 of the present embodiment has a structure in which toner is discharged to the outside of the cartridge by air, and does not need to be provided with a conveyance member (rotary member) such as a screw. Therefore, a cartridge of a simple structure with a small number of parts can be employed.

### Toner Conveyance Mechanism

The mechanism of conveyance of the toner stored in the toner chamber 41a of the toner cartridge 41 to corresponding one of the developing containers 3 will be described with reference to FIG. 7A.

The air supplied from the pump unit 50 is taken into the toner cartridge 41 through the air intake port 44. Specifically, as illustrated in FIG. 7A, the air discharged in the Y2 direction through each outlet port 50a is taken into the air chamber 41b of corresponding one of the toner cartridges 41 through the air intake port 44. The air flowing in increases the air pressure in the air chamber 41b, and thus air flows into the toner chamber 41a through the filter 42. The air having flowed into the toner chamber 41a fluidizes the toner by getting between particles of the toner. The toner mixed with air and thus fluidized flows into the toner path 43 through the toner intake port 43a together with the air, and is discharged to the outside of the toner cartridge 41 through the toner discharge port 43b. The toner discharge port 43b faces in the Y1 direction, and thus the air and toner are discharged in the Y1 direction.

By providing the air chamber 41b that is a space having high airtightness between the air intake port 44 and the filter 42, the air discharged through the outlet port 50a efficiently moves toward the filter 42 without scattering to the outside of the toner cartridge 41. For example, a situation in which toner in the toner chamber 41a is likely to aggregate, such as a case where the toner cartridge 41 receives vibration or is left unused for a long period, is assumed. In such a situation, the pressure required for causing the air to flow into the toner cartridge 41 through the filter 42 is likely to be high. Even in such a case, the air can be delivered into the toner chamber 41a through the filter 42 by continuing sending air into the air chamber 41b from the pump unit 50 and thus increasing the pressure (air pressure) in the air chamber 41b. In addition, as a result of providing the air chamber 41b, it suffices as long as the pump unit 50 has a performance to generate a pressure with which the air can be sent into the air chamber 41b until the pressure reaches a value required for the air to pass through the filter 42 into the toner chamber 41a. That is, there is no special requirement in the discharge speed and discharge amount, therefore a small pump unit can be employed, which contributes to miniaturization of the apparatus.

The toner discharged through the toner discharge port 43b of the toner cartridge 41 is conveyed to the developing container 3 of corresponding one of the process units P through corresponding one of the toner passages 51 together with the air. Specifically, the flow of toner and air having flowed into the toner passage 51 through the receiving port 51a is discharged through the delivery port 51b of the toner passage 51, and the toner and air flows into the developing container 3. As a result of this, toner is supplied from each toner cartridge 41 to corresponding one of the developing containers 3.

### Arrangement of Toner Passages

Next, the arrangement of the toner passages 51Y to 51K will be described. As illustrated in FIG. 5, in the present embodiment, the receiving port 51a and the delivery port 51b of each toner passage 51 are disposed at the same position in the X-axis direction (second direction). For example, regarding the yellow toner passage 51Y, at least a part of the receiving port 51aY (first receiving port) and at least a part of the delivery port 51bY (first delivery port) are in the same position in the X-axis direction. Regarding the magenta toner passage 51M, at least a part of the receiving port 51aM (second receiving port) and at least a part of the delivery port 51bM (second delivery port) are in the same position in the X-axis direction. In other words, the delivery port 51b of each toner passage 51 is at a position above corresponding one of the receiving ports 51a and overlapping the receiving port 51a as viewed in a direction (e.g., direction following the Z-axis direction) orthogonal to the X-axis direction.

In each of the toner passages 51Yto 51K, since the receiving port 51a and the delivery port 51b are at approximately the same position in the X-axis direction (second direction) as described above, the same configuration can be employed for the toner passages 51Y to 51K. As a result of this, for example, since the difference in the pressure loss between the toner passages 51Y to 51K becomes small, the control of the pump units 50Y to 50K can be simplified.

To be noted, it may be preferable that the distance from the receiving port 51a to the delivery port 51b in the gravity direction (Z-axis direction) is the same between the toner passages 51Y to 51K. For example, it may be preferable that the distance from the receiving port 51aY (first receiving port) to the delivery port 51bY (first delivery port) in the Z-axis direction is equal to the distance from the receiving port 51aM (second receiving port) to the delivery port 51bM (second delivery port) in the Z-axis direction. As a result of this, the difference in the path length between the toner passages 51Y to 51K can be reduced further, and thus the difference in the pressure loss can be reduced. It may be preferable that the path lengths of the toner passages 51Y to 51K are equal.

To be noted, the toner passage 51 of the present embodiment is supported by the main body 72, and the receiving port 51a is not drawn out to the outside of the main body 72 even when the toner cartridge tray 46 is drawn out. The configuration is not limited to this, and a configuration in which, for example, part of the toner passage 51 is provided in the toner cartridge tray 46 and part of the toner passage 51 is attached to and detached from another part in accordance with the insertion and draw-out of the toner cartridge tray 46 may be employed. In contrast, according to the configuration of the present embodiment, the number of attachment/detachment portions in the toner replenishment path from the toner cartridge 41 to the developing container 3 can be reduced, and thus the configuration of the toner replenishment path can be simplified.

### Attachment and Detachment of Process Unit and Toner Passage

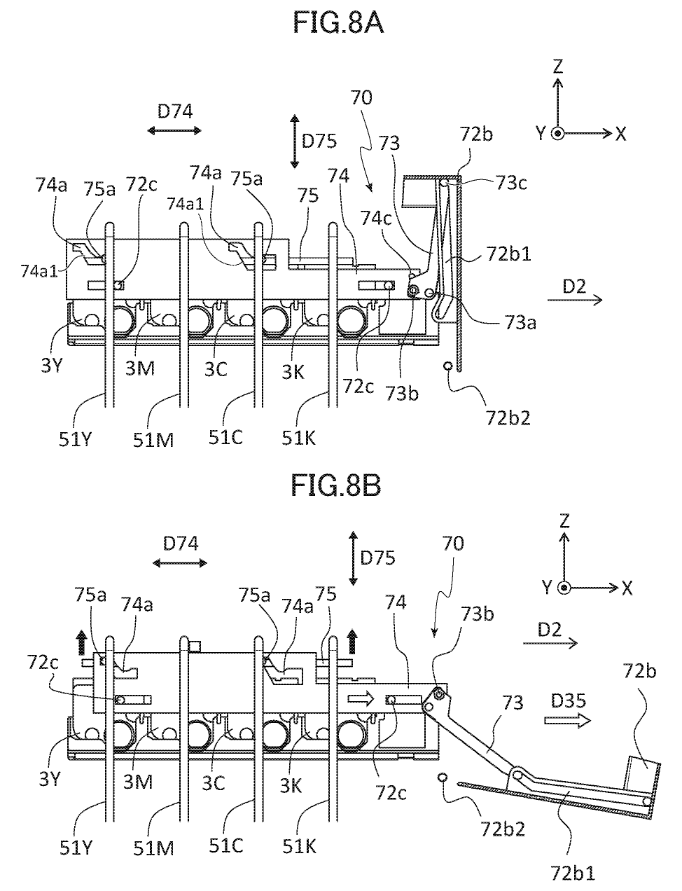

FIGS. 8A and 8B are each a diagram for describing the attachment/detachment operation of a connecting portion between the process unit P and the toner passage 51. FIG. 8A illustrates a state in which the front door 72b is closed, and FIG. 8B illustrates a state in which the front door 72b is open.

As illustrated in FIGS. 8A and 8B, the image forming apparatus 1 includes a front door interlocking mechanism 70 serving as a second interlocking mechanism that performs attachment and detachment (connection and disconnection) of the delivery port 51b of each toner passage 51 to and from the developing container 3 in an interlocked manner with the opening and closing of the front door 72b. The front door interlocking mechanism 70 of the present embodiment includes a link member 73, a slide member 74, and an up-down movement member 75.

The link member 73 includes a pivot shaft 73a pivotably supported by the frame body of the main body 72, an engaging portion 73b that engages with the slide member 74, and an engaging portion 73c that engages with an elongated hole 72b1 of the front door 72b. The link member 73 is pivotable about a pivot axis (axis extending in the Y-axis direction) parallel to a pivot shaft 72b2 of the front door 72b by using the pivot shaft 73a as a fulcrum.

The slide member 74 has a hole portion that engages with a support shaft 72c fixed to the frame body of the main body 72, an engaged portion 74c that engages with the engaging portion 73b of the link member 73, and a hole portion 74a that engages with the up-down movement member 75. The slide member 74 is supported by the support shaft 72c of the main body 72, and is thus capable of reciprocating in a slide direction D74 following the opening/closing direction of the front door 72b. The slide direction D74 of the slide member 74 may be parallel to the X-axis direction (second direction).

The up-down movement member 75 functions as a holding member (second holding member) that holds the delivery port 51b of each toner passage 51 and that is movable in an up-down direction (Z-axis direction) that is the attachment/detachment direction (second attachment/detachment direction) between the delivery port 51b and the developing container 3 in the present embodiment. The up-down movement member 75 includes a shaft portion 75a (see also FIG. 5) serving as a guided portion that engages with a guide portion of the main body 72. The guide portion of the main body 72 is, for example, an elongated hole extending in the Z-axis direction formed in the support member fixed to the frame body of the main body 72. As a result of the shaft portion 75a being engaged with the guide portion, the movement direction of the up-down movement member 75 is regulated to the up-down direction. In addition, the shaft portion 75a is also engaged with the hole portion 74a of the slide member 74.

The up-down movement member 75 is capable of reciprocating in a movement direction D75 intersecting with the slide direction D74 of the slide member 74 between a lower position and an upper position above the lower position. The movement direction D75 may be parallel to the Z-axis direction. The lower position is a position (attachment position, connecting position) where the up-down movement member 75 attaches the delivery port 51b of each toner passage 51 to corresponding one of the developing containers 3. The upper position is a position (detachment position, disconnecting position) where the up-down movement member 75 separates the delivery port 51b of each toner passage 51 from corresponding one of the developing containers 3. To be noted, each developing container 3 is provided with an opening portion (nozzle) to which the delivery port 51b of corresponding one of the toner passages 51 is detachably attached.

The hole portion 74a of the slide member 74 includes an inclined portion 74a1 inclined with respect to the slide direction D74. The inclined portion 74a1 is inclined downward toward the downstream side in the slide direction (rightward in FIG. 8A) of the slide member 74 in which the slide member 74 slides when the front door 72b is opened. As a result of the engagement between the hole portion 74a of the slide member 74 and the shaft portion 75a of the up-down movement member 75, the position of the up-down movement member 75 in the Z-axis direction serving as a second attachment/detachment direction is determined.

The slide member 74 functions as a second moving member that moves the up-down movement member 75 (second holding member) in the Z-axis direction (second attachment/detachment direction). The slide member 74 is engaged with the up-down movement member 75 (second holding member), and moves the up-down movement member 75 in the Z-axis direction by moving in the slide direction D74 following the X-axis direction (second direction) in an interlocked manner with the movement of the front door 72b (opening/closing member) from the closed position to the open position.

The operation of the front door interlocking mechanism 70 when opening the front door 72b will be described. When the front door 72b is at the closed position as illustrated in FIG. 8A, the up-down movement member 75 is held at the lower position. In addition, the delivery port 51b of each toner passage 51 is maintained in the state of being attached to corresponding one of the developing containers 3 by the up-down movement member 75 positioned at the lower position.

When the front door 72b is moved from the closed position toward the open position, the link member 73 pivots in a clockwise direction in the drawings in an interlocked manner with the front door 72b pivoting about the pivot shaft 72b2. In addition, the slide member 74 moves in the slide direction D74 (rightward in the drawings) in an interlocked manner with the pivot of the link member 73. Then, the shaft portion 75a of the up-down movement member 75 is lifted up by the inclined portion 74a1 of the hole portion 74a of the slide member 74. Therefore, the up-down movement member 75 moves from the lower position to the upper position before the front door 72b reaches the open position as illustrated in FIG. 8B.

When the up-down movement member 75 moves from the lower position to the upper position, the delivery port 51b of each toner passage 51 is moved upward, and is thus detached from corresponding one of the developing containers 3. As a result of this, the connection between each toner passage 51 and corresponding one of the process units P is cancelled. In this manner, the user can draw out the process unit tray 35 to the outside of the main body 72 in a state in which the connection between the toner passage 51 and the developing container 3 is cancelled in accordance with the opening of the front door 72b.

To be noted, the operation of the front door interlocking mechanism 70 when closing the front door 72b is performed in a process reversed from what has been described above. That is, when the front door 72b is moved from the open position to the closed position, the slide member 74 moves in the slide direction D74 (leftward in FIG. 8B) in an interlocked manner with the front door 72b via the link member 73. Then, the up-down movement member 75 is moved from the upper position to the lower position by the inclined portion 74a1 of the hole portion 74a of the slide member 74. As a result, the delivery port 51b of each toner passage 51 is moved downward, and is attached to corresponding one of the developing containers 3. That is, the connection between each toner passage 51 and corresponding one of the process units P is completed by the operation by the user to close the front door 72b.

The front door interlocking mechanism 70 is an example of an interlocking mechanism that attaches and detaches the toner passage 51 to and from the process unit P in an interlocked manner with the opening and closing of the front door 72b (opening/closing member), and the specific configuration of the interlocking mechanism is not limited to what has been described above. For example, part of the front door 72b may be directly engaged with the slide member 74 instead of via the link member 73.

In addition, although a configuration in which the front door 72b is moved in an interlocked manner with the up-down movement member 75 by the front door interlocking mechanism 70 is employed in the present embodiment, an operation portion with which the user can manually attach and detach the toner passage 51 to and from the process unit P may be provided instead of the front door interlocking mechanism 70. For example, the slide member 74 may be provided with a grip portion, and the up-down movement member 75 may be configured to move from the lower position to the upper position when the user pulls the grip portion after opening the front door 72b.

### Attachment and Detachment of Toner Cartridge and Toner Passage

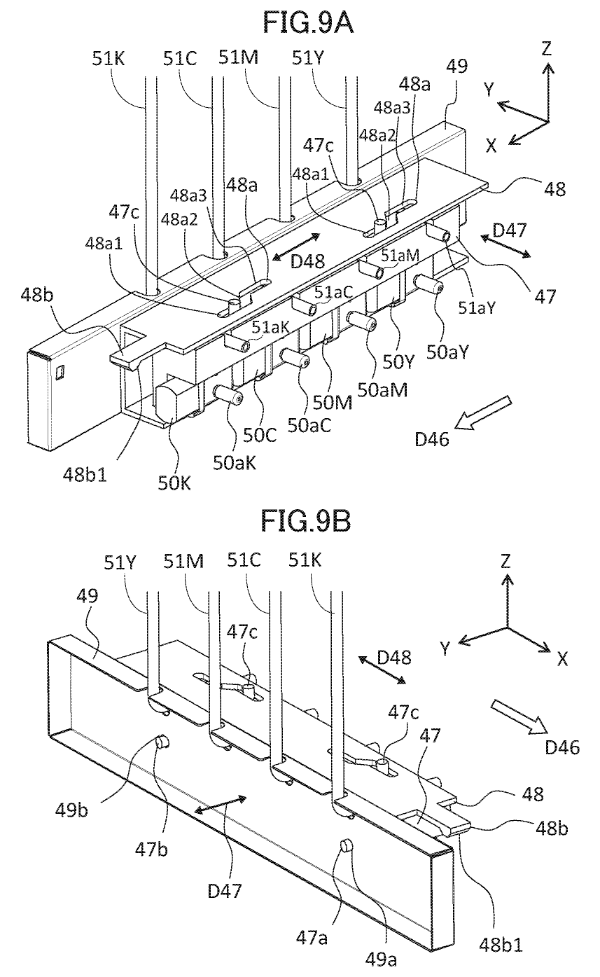

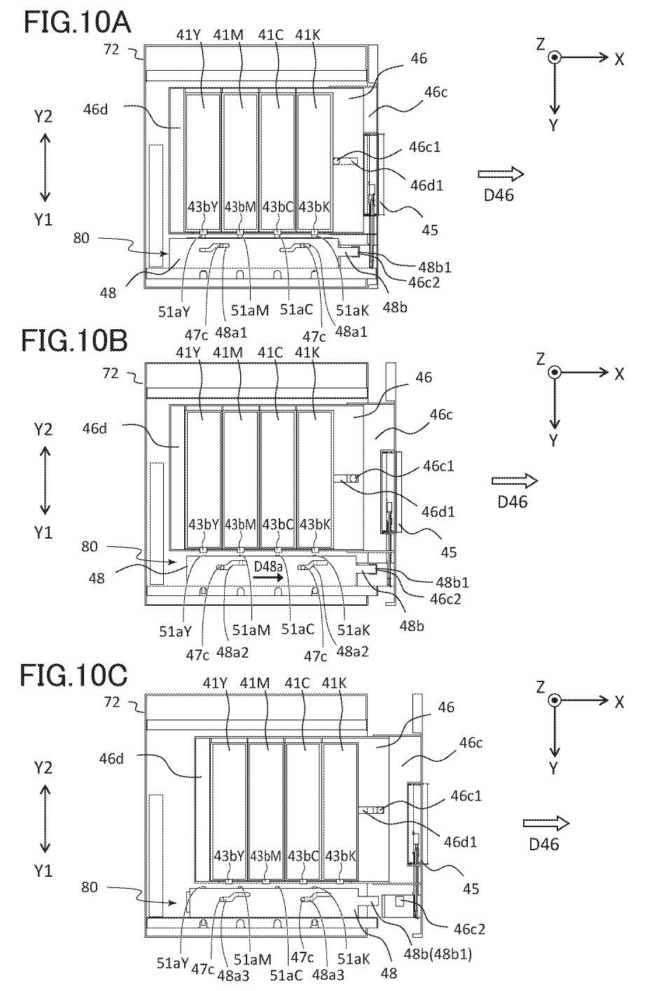

The operation in attachment and detachment of the toner cartridge 41 will be described with reference to FIGS. 7, 9, and 10. FIGS. 9A and 9B are each a perspective view of a holding mechanism 80 holding the pump units 50Y to 50K and the toner passages 51Y to 51K. FIGS. 10A to 10C are each a top view illustrating the operation of the holding mechanism 80 when drawing out the toner cartridge tray 46. FIG. 10A illustrates a state in which the toner cartridge tray 46 is attached to the main body 72. FIG. 10B illustrates a state in which the toner cartridge tray 46 has been drawn out a little from the main body 72. FIG. 10C illustrates a state in which the toner cartridge tray 46 has been drawn out further from the state of FIG. 10B.

As illustrated in FIGS. 9A and 9B, the toner replenishment unit 40 includes the holding mechanism 80 that hold the pump units 50Y to 50K and the toner passages 51Y to 51K. The holding mechanism 80 includes a holding member 47, a slide member 48, and a left side plate 49.

As will be described below, the holding mechanism 80 functions as a first interlocking mechanism that detaches the receiving port 51a of each toner passage 51 from the toner discharge port 43b of corresponding one of the toner cartridges 41 in an interlocked manner with the operation of drawing out the toner cartridge tray 46 (first support member). In addition, the holding mechanism 80 functions as a first interlocking mechanism that detaches the outlet port 50a of each pump unit 50 from the air intake port 44 of corresponding one of the toner cartridges 41 in an interlocked manner with the operation of drawing out the toner cartridge tray 46 (first support member).

The left side plate 49 is a plate-shaped frame member provided at an end portion of the main body 72 on the left side (+Y side) and extending in the X-axis direction and the Z-axis direction. The left side plate 49 is part of the frame body of the main body 72. To be noted, the main body 72 includes a right side plate opposing the left side plate 49 in the Y-axis direction, and a space accommodating the toner cartridge tray 46 to which the toner cartridges 41 are attached is formed between the left side plate 49 and the right side plate.

The slide member 48 is slidably supported by the left side plate 49. The slide member 48 is capable of reciprocating in a slide direction D48 following the draw-out direction D46 of the toner cartridge tray 46.

The holding member 47 includes the pump units 50Y to 50K and the receiving ports 51a of the toner passages 51Y to 51K. The holding member 47 includes a first positioning shaft 47a, a second positioning shaft 47b, and a slide shaft 47c.

The first positioning shaft 47a and the second positioning shaft 47b are each a shaft portion extending in the Y-axis direction, and are respectively engaged with a first hole portion 49a and a second hole portion 49b (FIG. 9B) formed in the left side plate 49. As a result of the engagement between the first positioning shaft 47a and the first hole portion 49a and the engagement between the second positioning shaft 47b and the second hole portion 49b, the position of the holding member 47 in the X-axis direction and the Z-axis direction is determined. Meanwhile, the engagement between the first positioning shaft 47a and the second positioning shaft 47b and the first hole portion 49a and the second hole portion 49b allows the movement of the holding member 47 in the Y-axis direction.

The holding member 47 is capable of reciprocating in a movement direction D47 following the Y-axis direction. That is, the holding member 47 serving as a first holding member that holds the outlet port 50a of each pump unit 50 is movable in a first attachment/detachment direction (movement direction D47) which intersects with the X-axis direction (second direction) and in which each outlet port 50a is attached to and detached from corresponding one of the air intake ports 44.

The holding member 47 is movable to a connecting position where the outlet port 50a of each pump unit 50 and the receiving port 51a of each toner passage 51 are connected to corresponding one of the toner cartridges 41, and a retracted position where the outlet port 50a and the receiving port 51a are more retracted from the toner cartridge 41 than at the connecting position. The retracted position is a position on the far side (+Y side) from the toner cartridge 41 in the Y-axis direction with respect to the connecting position.

The slide shaft 47c is a shaft portion protruding in the Z-axis direction. In the holding member 47 of the present embodiment, two slide shafts 47c each protruding in the Z-axis direction are arranged side by side in the X-axis direction.

The slide member 48 has two elongated hole portions 48a that respectively engage with the slide shafts 47c. The slide member 48 is formed in a U shape opening on the -Y side as viewed in the X-axis direction, and the holding member 47 is accommodated in the inner space of the U shape. In the Z-axis direction, the two elongated hole portions 48a penetrate the top surface portion of the slide member 48 covering the upper side of the holding member 47.

The elongated hole portions 48a each include a first straight portion 48a1 and a second straight portion 48a3 extending approximately parallel to the Y-axis direction, and an inclined portion 48a2 formed between the first straight portion 48a1 and the second straight portion 48a3. As a result of the engagement between the slide shafts 47c of the holding member 47 and the elongated hole portions 48a of the slide member 48, the position of the holding member 47 in the Y-axis direction is regulated.

The first straight portion 48a1 is positioned on the side (-Y side) closer to the toner cartridge 41 than the second straight portion 48a3 in the Y-axis direction. In addition, the first straight portion 48a1 is positioned downstream of the second straight portion 48a3 in the movement direction D48a of the slide member 48 in which the slide member 48 moves when drawing out the toner cartridge tray 46. The first straight portion 48a1, the inclined portion 48a2, and the second straight portion 48a3 are formed continuously at a constant opening width with which the slide shaft 47c of the holding member 47 can be received therein.

The inclined portion 48a2 is inclined such that a portion of the inclined portion 48a2 closer to the boundary between the inclined portion 48a2 and the first straight portion 48a1 extends more to the side (-Y side) closer to the toner cartridge 41 in the Y-axis direction starting from the boundary between the inclined portion 48a2 and the second straight portion 48a3. In other words, the inclined portion 48a2 is inclined such that part thereof more downstream in the movement direction D48a of the slide member 48 in which the slide member 48 moves when drawing out the toner cartridge tray 46 is closer to the toner cartridge 41 in the Y-axis direction.

As described above, the slide member 48 serving as a first moving member is engaged with the holding member 47 serving as a first holding member. The slide member 48 moves the holding member 47 (first holding member) in the movement direction D47 (first attachment/detachment direction) by moving in a direction following the X-axis direction (second direction) in an interlocked manner with the operation of drawing out the toner cartridge tray 46 (first support member).

As illustrated in FIGS. 10C and 6, the toner cartridge tray 46 includes a tray front portion 46c (first portion) where a handle portion 45 is provided, and a tray rear portion 46d (second portion) coupled to the tray front portion 46c. The first positioning portion 46a and the second positioning portion 46b of the toner cartridge tray 46 described above are provided in the tray rear portion 46d. The tray rear portion 46d supports each toner cartridge 41. The tray rear portion 46d supports each toner cartridge 41.

The tray front portion 46c and the tray rear portion 46d are coupled to each other so as to be relatively movable (capable of extending and contracting) in a predetermined range. Specifically, an elongated hole portion 46d1 extending in the draw-out direction D46 of the toner cartridge tray 46 is provided in the tray rear portion 46d. A shaft portion 46c1 that engages with the elongated hole portion 46d1 is provided in the tray front portion 46c. The shaft portion 46c1 and the elongated hole portion 46d1 are an example of a coupling portion that relatively movably couples the tray front portion 46c and the tray rear portion 46d together. The configuration of the coupling portion is not limited to this, and for example, an elongated hole portion may be provided in the tray front portion 46c, and a shaft portion that engages with the elongated hole portion may be provided in the tray rear portion 46d.

In addition, the tray front portion 46c is provided with a recess portion 46c2 that engages with a protrusion portion 48b1 of the slide member 48 (FIGS. 9A and 9B). The protrusion portion 48b1 of the slide member 48 is provided at a distal end portion 48b of the slide member 48 in the draw-out direction D46 of the toner cartridge tray 46, and protrudes in a direction intersecting with the draw-out direction D46 (gravity direction in the present embodiment). The recess portion 46c2 is a shape recessed in the gravity direction so as to receive the protrusion portion 48b1 of the slide member 48.

In a state in which the toner cartridge tray 46 is accommodated in the main body 72 as illustrated in FIG. 10A, the shaft portion 46c1 of the tray front portion 46c is positioned at an upstream end portion of the elongated hole 46d1 in the draw-out direction D46. In addition, in the state of FIG. 10A, the recess portion 46c2 of the tray front portion 46c is engaged with the protrusion portion 48b1 of the slide member 48. In addition, in the state of FIG. 10A, the slide shafts 47c of the holding member 47 are positioned in the first straight portions 48a1 of the elongated hole portions 48a of the slide member 48.

When the slide shafts 47c are positioned at the first straight portions 48a1, the holding member 47 is held at the connecting position. That is, in the state of FIG. 10A, the outlet port 50a of each pump unit 50 is connected to the air intake port 44 of corresponding one of the toner cartridges 41, and the receiving port 51a of each toner passage 51 is connected to the toner discharge port 43b of corresponding one of the toner cartridges 41.

When the user grips the handle portion 45 and pulls the handle portion 45 in the draw-out direction D46 from the state of FIG. 10A, the tray front portion 46c first starts moving in the draw-out direction D46 as illustrated in FIG. 10B. At this time, the shaft portion 46c1 of the tray front portion 46c moves in the draw-out direction D46 on the inside of the elongated hole portion 46d1 of the tray rear portion 46d while the tray rear portion 46d stays inside the main body 72.

As a result of the engagement between the protrusion portion 48b1 and the recess portion 46c2, the slide member 48 moves in the movement direction D48a following the draw-out direction D46 in an interlocked manner with the movement of the tray front portion 46c in the draw-out direction D46. When the slide member 48 moves in the movement direction D48a, the slide shafts 47c of the holding member 47 start abutting the inclined portions 48a2 instead of the first straight portions 48a1 of the elongated hole portions 48a of the slide member 48. The holding member 47 is positioned in the X-axis direction and the Z-axis direction as described above, and is therefore moved in the Y-axis direction as a result of the slide shafts 47c being pressed by the wall surface of the inclined portions 48a2. Therefore, the holding member 47 moves in a direction (+Y direction) from the connecting position toward the retracted position in the Y-axis direction. When the slide member 48 further moves in the movement direction D48a, the second straight portions 48a3 engage with the slide shafts 47c instead of the inclined portions 48a2.

When the slide shafts 47c are positioned at the second straight portions 48a3, the holding member 47 is held at the retracted position. That is, in the state of FIG. 10B, the outlet port 50a of each pump unit 50 is separated from the air intake port 44 of corresponding one of the toner cartridges 41 (see FIG. 7B). In addition, in the state of FIG. 10B, the receiving port 51a of each toner passage 51 is separated from the toner discharge port 43b of corresponding one of the toner cartridges 41 (see FIG. 7B).

To be noted, it may be preferable that, in the course of movement of the tray front portion 46c in the draw-out direction D46, after the outlet port 50a of the pump unit 50 is separated from the air intake port 44, the receiving port 51a of corresponding one of the toner passages 51 is separated from the toner discharge port 43b. That is, the timing at which the first receiving port and the second receiving port are separated from the first discharge port and the second discharge port when the first support member is drawn out from the inner position toward the outer position may preferably be later than a timing at which the first outlet port and the second outlet port are separated from the first intake port and the second intake port.

There is a case where the inner pressure of the toner cartridge 41 is higher than the atmospheric pressure immediately after toner replenishment. If the receiving port 51a is separated in a state in which the outlet port 50a has been separated first and thus the inner pressure has been lowered, the toner is less likely to leak from the toner discharge port 43b when the receiving port 51a and the toner discharge port 43b are separated.

When the tray front portion 46c is further drawn out in the draw-out direction D46 from the state of FIG. 10B, the shaft portion 46c1 of the tray front portion 46c abuts the downstream end portion of the elongated hole portion 46d1 in the draw-out direction D46 as illustrated in FIG. 10C. After this, the tray front portion 46c and the tray rear portion 46d integrally move in the draw-out direction D46. That is, the shaft portion 46c1 and the elongated hole portion 46d1 serving as a coupling portion allow the tray front portion 46c (first portion) to individually move in the X-axis direction (second direction) without moving the tray rear portion 46d (second portion) before each outlet port 50a is separated from corresponding one of the air intake ports 44. In addition, the shaft portion 46c1 and the elongated hole portion 46d1 serving as a coupling portion move the tray rear portion 46d (second portion) in the X-axis direction (second direction) together with the tray front portion 46c (first portion) after each outlet port 50a is separated from corresponding one of the air intake ports 44. According to this configuration, the movement of the toner cartridge 41 can be started in a state in which the connection between the outlet port 50a and the air intake port 44 is more reliably cancelled.

Similarly, the shaft portion 46c1 and the elongated hole portion 46d1 serving as a coupling portion allow the tray front portion 46c (first portion) to individually move in the X-axis direction (second direction) without moving the tray rear portion 46d (second portion) before each receiving port 51a is separated from corresponding one of the toner discharge ports 43b. In addition, the shaft portion 46c1 and the elongated hole portion 46d1 serving as a coupling portion move the tray rear portion 46d (second portion) in the X-axis direction (second direction) together with the tray front portion 46c (first portion) after each receiving port 51a is separated from corresponding one of the toner discharge ports 43b. According to this configuration, the movement of the toner cartridge 41 can be started in a state in which the connection between the receiving port 51a and the toner discharge port 43b is more reliably cancelled.

In addition, the movement of the slide member 48 in the movement direction D48a is regulated as a result of the slide shafts 47c of the holding member 47 abutting end portions of the second straight portions 48a3 of the elongated hole portions 48a of the slide member 48. Then, the protrusion portion 48b1 provided at the distal end portion 48b of the slide member 48 receives upward force from the recess portion 46c2 of the tray front portion 46c, thus the distal end portion 48b warps, the protrusion portion 48b1 is separated from the recess portion 46c2, and the engagement between the tray front portion 46c and the slide member 48 is cancelled. As a result of this, the toner cartridge tray 46 can be drawn out further in the draw-out direction D46 without being interrupted by the slide member 48.

As described above, the user can replace the toner cartridge 41 by attaching and detaching each toner cartridge 41 to and from the toner cartridge tray 46 in a state in which the toner cartridge tray 46 is drawn out to the outside of the main body 72.

To be noted, the operation of the holding mechanism 80 in the case of attaching the toner cartridge tray 46 to the main body 72 is performed in a process reversed from the case of drawing out the toner cartridge tray 46 described above. That is, when the toner cartridge tray 46 drawn out from the main body 72 is inserted in a direction opposite to the draw-out direction D46, the recess portion 46c2 of the tray front portion 46c engages with the protrusion portion 48b1 of the slide member 48. The slide member 48 moves in a direction opposite to the movement direction D48a in which the slide member 48 moves when drawing out the toner cartridge tray 46. The holding member 47 is moved from the retracted position to the connecting position by the inclination of the inclined portions 48a2 of the elongated hole portions 48a in accordance with the movement of the slide member 48. As a result of this, the outlet port 50a of each pump unit 50 and the receiving port 51a of each toner passage 51 are connected to the air intake port 44 and the toner discharge port 43b of corresponding one of the toner cartridges 41. In addition, as a result of the shaft portion 46c1 of the tray front portion 46c engaging with an end portion of the elongated hole portion 46d1 of the tray rear portion 46d, the toner cartridge tray 46 is attached to a position illustrated in FIG. 10A.

The holding mechanism 80 described above is an example of an interlocking mechanism that attaches and detaches each outlet port 50a and each receiving port 51a to and from corresponding one of the toner cartridges 41 in an interlocked manner with the operation of the toner cartridge tray 46, and the specific configuration of the interlocking mechanism is not limited to what has been described above. For example, the slide member 48 may be connected to the handle portion 45 such that each outlet port 50a and each receiving port 51a are separated from the toner cartridge 41 by the operation of the handle portion 45.

According to the present disclosure, a new technique relating to an arrangement of toner containers storing toner for replenishment in an image forming apparatus can be provided.

### Other Embodiments

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-020948, filed Feb. 12, 2025, which is hereby incorporated by reference herein in its entirety.

What is claimed is:

1. An image forming apparatus comprising:
a main body;
a first developing unit including a first developing container configured to store first toner, and
a first developing roller configured to bear the first toner;
a second developing unit including a second developing container configured to store second toner, and
a second developing roller configured to bear the second toner;
an air supplying portion configured to supply air;
a first toner container that is attachable to and detachable from the main body and
configured to store the first toner and discharge the first toner by the air supplied from the air supplying portion;
a second toner container that is attachable to and detachable from the main body and
configured to store the second toner and discharge the second toner by the air supplied from the air supplying portion;
a first passage which communicates with the first toner container and the first developing container and through which
the first toner passes when the first toner discharged from the first toner container is conveyed to the first developing container by the air; and
a second passage which communicates with the second toner container and the second developing container and through which the second toner passes when the second toner discharged from the second toner container is conveyed to the second developing container by the air,
wherein in a case where a direction of a rotation axis of the first developing roller is a first direction and a direction intersecting with both a gravity direction and the first direction is a second direction,
the first developing unit and the second developing unit are aligned in the second direction, and
the first toner container and the second toner container are aligned in the second direction, and are respectively arranged below the first developing unit and the second developing unit in the gravity direction.

2. The image forming apparatus according to claim 1, wherein
as viewed in the gravity direction, the first developing unit overlaps the first toner container, and the second developing unit overlaps the second toner container.

3. The image forming apparatus according to claim 1, wherein
the first passage is configured such that the first toner is conveyed from the first toner container to the first developing container through the first passage by the air discharged together with the first toner from the first toner container, and
the second passage is configured such that the second toner is conveyed from the second toner container to the second developing container through the second passage by the air discharged together with the second toner from the second toner container.

4. The image forming apparatus according to claim 1, further comprising:
a first support member configured to support the first toner container and the second toner container and movable to an inner position where the first support member is accommodated in the main body and an outer position where the first support member is drawn out of the main body,
wherein a direction in which the first support member is drawn out from the inner position toward the outer position is a direction following the second direction.

5. The image forming apparatus according to claim 4, further comprising:
a second support member configured to support the first developing unit and the second developing unit and movable to a second inner position where the second support member is accommodated in the main body and a second outer position where the second support member is drawn out of the main body,
wherein a direction in which the second support member is drawn out from the second inner position toward the second outer position is a direction following the second direction.

6. The image forming apparatus according to claim 1, wherein
a length of the first toner container in the first direction is larger than a length of the first toner container in a direction orthogonal to the first direction, and
a length of the second toner container in the first direction is larger than a length of the second toner container in a direction orthogonal to the first direction.

7. The image forming apparatus according to claim 1, wherein
the first passage extends to a position below the first developing container through a position that is outside the first developing container in the first direction and that overlaps the first developing container as viewed in the first direction, and
the second passage extends to a position below the second developing container through a position that is outside the second developing container in the first direction and that overlaps the second developing container as viewed in the first direction.

8. The image forming apparatus according to claim 1, wherein
the first passage includes a first receiving port configured to receive the first toner and the air discharged from the first toner container, and a first delivery port configured to deliver the first toner and the air to the first developing container,
the second passage includes a second receiving port configured to receive the second toner and the air discharged from the second toner container, and a second delivery port configured to deliver the second toner and the air to the second developing container,
at least a part of the first receiving port and at least a part of the first delivery port are in the same position in the second direction, and
at least a part of the second receiving port and at least a part of the second delivery port are in the same position in the second direction.

9. The image forming apparatus according to claim 8, wherein
a distance from the first receiving port to the first delivery port in the gravity direction is equal to a distance from the second receiving port to the second delivery port.

10. The image forming apparatus according to claim 1, further comprising:
a first support member configured to support the first toner container and the second toner container and movable to an inner position where the first support member is accommodated in the main body and an outer position where the first support member is drawn out of the main body,
wherein the air supplying portion includes a first outlet port and a second outlet port that are configured to discharge the air,
the first toner container includes a first intake port which is connected to the first outlet port and configured to take in the air discharged through the first outlet port,
the second toner container includes a second intake port which is connected to the second outlet port and configured to take in the air discharged through the second outlet port, and
the image forming apparatus further comprises a first interlocking mechanism configured to separate the first outlet port and the second outlet port respectively from the first intake port and the second intake port in an interlocked manner with an operation of drawing out the first support member from the inner position toward the outer position.

11. The image forming apparatus according to claim 10,
wherein the first interlocking mechanism includes:
a first holding member configured to hold the first outlet port and the second outlet port and movable in a first attachment/detachment direction in which attachment and detachment of the first outlet port and the second outlet port to and from the first intake port and the second intake port is performed; and
a first moving member engaged with the first holding member and configured to move in a direction following the second direction in an interlocked manner with the operation of drawing out the first support member and thus move the first holding member in the first attachment/detachment direction.

12. The image forming apparatus according to claim 11, wherein
the first support member includes:
a first portion including a grip portion configured to be gripped by a user;
a second portion configured to support the first toner container and the second toner container; and
a coupling portion configured to relatively movably couple the first portion and the second portion, and
the coupling portion is configured to, in a case where the grip portion is gripped and the first support member is drawn out from the inner position:
allow the first portion to individually move in the second direction without moving the second portion before the first outlet port and the second outlet port are separated from the first intake port and the second intake port; and
move the second portion in the second direction together with the first portion after the first outlet port and the second outlet port are separated from the first intake port and the second intake port.

13. The image forming apparatus according to claim 10, wherein
the first toner container includes a first discharge port configured to discharge the first toner and the air,
the second toner container includes a second discharge port configured to discharge the second toner and the air,
the first passage includes a first receiving port configured to receive the first toner and the air discharged from the first discharge port,
the second passage includes a second receiving port configured to receive the second toner and the air discharged from the second discharge port, and
the first interlocking mechanism is configured to separate the first receiving port and the second receiving port respectively from the first discharge port and the second discharge port in an interlocked manner with the operation of drawing out the first support member from the inner position toward the outer position.

14. The image forming apparatus according to claim 13, wherein
in a case where the first support member is drawn out from the inner position toward the outer position, a timing at which the first receiving port and the second receiving port are separated from the first discharge port and the second discharge port is later than a timing at which the first outlet port and the second outlet port are separated from the first intake port and the second intake port.

15. The image forming apparatus according to claim 1, further comprising:
a first support member configured to support the first toner container and the second toner container and movable to an inner position where the first support member is accommodated in the main body and an outer position where the first support member is drawn out of the main body,
wherein the first toner container includes a first discharge port configured to discharge the first toner and the air,
the second toner container includes a second discharge port configured to discharge the second toner and the air,
the first passage includes a first receiving port configured to receive the first toner and the air discharged from the first discharge port,
the second passage includes a second receiving port configured to receive the second toner and the air discharged from the second discharge port, and
the image forming apparatus further comprises a first interlocking mechanism configured to separate the first receiving port and the second receiving port respectively from the first discharge port and the second discharge port in an interlocked manner with an operation of drawing out the first support member from the inner position toward the outer position.

16. The image forming apparatus according to claim 1, wherein
the main body is provided with an opening and includes an opening/closing member movable to a closed position where the opening/closing member closes the opening and an open position where the opening/closing member opens the opening,
attachment and detachment of the first developing unit and the second developing unit to and from the main body is performed through the opening in a state in which the opening/closing member is at the open position,
the first passage includes a first delivery port configured to deliver the first toner to the first developing container,
the second passage includes a second delivery port configured to deliver the second toner to the second developing container, and
the image forming apparatus further comprises a second interlocking mechanism configured to separate the first delivery port and the second delivery port respectively from the first developing container and the second developing container in an interlocked manner with movement of the opening/closing member from the closed position to the open position.

17. The image forming apparatus according to claim 16, wherein
the second interlocking mechanism includes:
a second holding member configured to hold the first delivery port and the second delivery port and movable in a second attachment/detachment direction in which attachment and detachment of the first delivery port and the second delivery port to and from the first developing container and the second developing container is performed; and
a second moving member engaged with the second holding member and configured to move in a direction following the second direction in an interlocked manner with the movement of the opening/closing member from the closed position to the open position and thus move the second holding member in the second attachment/detachment direction.

18. An image forming apparatus comprising:
a main body;
a first developing unit including a first developing container configured to store first toner, and a first developing roller configured to bear the first toner;
a second developing unit including a second developing container configured to store second toner, and a second developing roller configured to bear the second toner;
a moving unit that the first developing unit and the second developing unit are attachable to and detachable from and that is movable between an inner position and an outer position with respect to the main body in a state in which the first developing unit and the second developing unit are attached to the moving unit, the inner position being a position where the first developing unit and the second developing unit are in the main body, the outer position being a position where the first developing unit and the second developing unit are exposed to an outside of the main body,
a first toner container that is attachable to and detachable from the main body and configured to store the first toner and discharge the first toner;
a second toner container that is attachable to and detachable from the main body and configured to store the second toner and discharge the second toner;
a first passage which communicates with the first toner container and the first developing container and through which the first toner passes when the first toner discharged from the first toner container is conveyed toward the first developing container; and
a second passage which communicates with the second toner container and the second developing container and through which the second toner passes when the second toner discharged from the second toner container is conveyed toward the second developing container,
wherein in a case where a direction of a rotation axis of the first developing roller is a first direction and a direction intersecting with both a gravity direction and the first direction is a second direction,
the first developing unit and the second developing unit are aligned in the second direction,
the moving unit is movable in the second direction with respect to the main body, and
the first toner container and the second toner container are aligned in the second direction, and are respectively arranged below the first developing unit and the second developing unit in the gravity direction.

19. The image forming apparatus according to claim 18, wherein
as viewed in the gravity direction, the first developing unit overlaps the first toner container, and the second developing unit overlaps the second toner container.

20. The image forming apparatus according to claim 19, wherein
in a case where the moving unit is a first moving unit and the inner position and the outer position are respectively a first inner position and a first outer position,
the image forming apparatus further comprises a second moving unit attachable to and detachable from the first toner container and the second toner container, and
the second moving unit is movable in the second direction between a second inner position where the first toner container and the second toner container are in the main body and a second outer position where the first toner container and the second toner container are exposed to an outside of the main body with respect to the main body.

21. An image forming apparatus comprising:
a main body;
a first developing unit provided in the main body and including a first developing container configured to
store first toner, and a first developing roller configured to bear the first toner;
a second developing unit provided in the main body and including a second developing container configured to
store second toner, and a second developing roller configured to bear the second toner;
a first toner container configured to store the first toner and discharge the first toner;
a second toner container configured to store the second toner and discharge the second toner;
a moving unit that the first toner container and the second toner container are attachable to and
detachable from and that is movable between an inner position and an outer position with respect to the main body in a state in which
the first toner container and the second toner container are attached to the moving unit,
the inner position being a position where the first toner container and the second toner container are in the main body,
the outer position being a position where the first toner container and the second toner container are exposed to an outside of the main body,
a first passage which communicates with the first toner container and the first developing container and through which the first toner passes when the first toner discharged from the first toner container is conveyed toward the first developing container; and
a second passage which communicates with the second toner container and the second developing container and through which the second toner passes when the second toner discharged from the second toner container is conveyed toward the second developing container,
wherein in a case where a direction of a rotation axis of the first developing roller is a first direction and
a direction intersecting with both a gravity direction and the first direction is a second direction,
the first developing unit and the second developing unit are aligned in the second direction,
the first toner container and the second toner container are aligned in the second direction, and are respectively arranged below the first developing unit and the second developing unit in the gravity direction, and
the moving unit is movable in the second direction with respect to the main body.

22. The image forming apparatus according to claim 21, wherein
as viewed in the gravity direction, the first developing unit overlaps the first toner container, and the second developing unit overlaps the second toner container.
